(19) United States
(12) Patent Application Publication
(10) Pub. No.: US 2026/0307149 A1
(43) Pub. Date: Oct. 8, 2026

(54) COMPOSITIONS, COMPRISING SILVER NANOPLATELETS

(71) Applicant: BASF SE, Ludwigshafen am Rhein (DE)

(72) Inventors: Nikolay A. GRIGORENKO, Basel (CH); Vincent RUFFIEUX, Le Mouret (CH); Herve PITTET, Chatel-St-Denis (CH)

(21) Appl. No.: 19/481,661

(22) PCT Filed: May 7, 2024
(86) PCT No.: PCT/EP2024/062650

§ 371 Date: Nov. 5, 2025

(30) Foreign Application Priority Data
May 8, 2023 (EP) 23172155.6

(51) Int. Cl. B22F 9/24; B22F 1/054; B22F 1/0545; B42D 25/328; B42D 25/364; B42D 25/373; B42D 25/391; C09D 7/40; C09D 7/62; C09D 11/101

(52) U.S. Cl. CPC B22F 9/24; B22F 1/0545; B22F 1/0551; B42D 25/328; B42D 25/364; B42D 25/373; B42D 25/391; C09D 7/62; C09D 7/67; C09D 7/70; C09D 11/101; B22F 2301/255; B22F 2304/054

(57) ABSTRACT

The present invention relates to compositions, comprising silver nanoplatelets, wherein the silver nanoplatelets are capped by a compound of formula

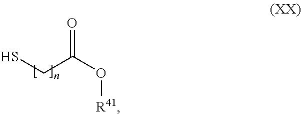

wherein R⁴¹ is a C₄-C₂₅alkyl group, which may be interrupted by one, or more oxygen atoms, and n is a number 1 to 10, especially 1 to 4, very especially 1, or 2, a process for its production, printing inks containing the compositions and their use in security products. The capping with the compound of formula (XX) renders the surface on the nanoparticles more hydrophobic, while maintaining colloidal stability of their dispersions in organic solvents and/or monomer compositions. This combination of properties allows for production of stable UV curable coating/printing compositions, suitable for manufacture of dichroic security elements for protection of value documents. The surface modification, described in the present invention is suitable for silver nanoplatelets of different sizes and, correspondingly, colors, and is especially useful for manufacture of solvent-free coating, or printing compositions.

The present invention relates to compositions, comprising silver nanoplatelets, wherein the silver nanoplatelets are capped by a compound of formula (XX), wherein R⁴¹ is a C₄-C₂₅alkyl group, which may be interrupted by one, or more oxygen atoms, and n is a number 1 to 10, especially 1 to 4, very especially 1, or 2, a process for its production, printing inks containing the compositions and their use in security products. Such capping renders the surface on the nanoparticles more hydrophobic, while maintaining colloidal stability of their dispersions in organic solvents and/or monomer compositions. This combination of properties allows for production of stable UV curable coating/printing compositions, suitable for manufacture of dichroic, i.e. showing one color upon observation in transmission and another color upon observation in reflection, security elements for protection of value documents, such as banknotes, ID cards, passports, etc. against counterfeiting. The surface modification, described in the present invention is suitable for silver nanoplatelets of different sizes and, correspondingly, colors, and is especially useful for manufacture of solvent-free coating, or printing compositions.

US2017246690 (EP3157697) discloses a method for synthesizing metal nanoparticles, the method comprising:
(a) preparing a metal precursor mixture comprising a metal precursor compound and a first aqueous liquid medium,
(b) preparing a reducing agent mixture comprising a reducing agent and a second aqueous liquid medium,
(c) optionally adding an acid or a base to the mixture prepared in step (a) or to the mixture prepared in step (b),
wherein the metal precursor mixture and the reducing agent mixture are both free of stabilizing agent and free of seed particles,
(d) combining the metal precursor mixture with the reducing agent mixture so as to allow the metal precursor compound to react with the reducing agent,
thereby synthesizing the metal nanoparticles.

EP3156156 relates to a fine silver particle dispersion, which comprises fine silver particles, a short chain amine having 5 or less carbon atoms and a highly polar solvent, and a partition coefficient log P of the short chain amine is −1.0 to 1.4. The method for producing the fine silver particles of EP3156156 comprises a first step for preparing a mixed liquid of a silver compound which is decomposed by reduction to produce a metal silver, and a short chain amine having a partition coefficient log P of −1.0 to 1.4, and a second step for reducing the silver compound in the mixed liquid to produce a fine silver particle where a short chain amine having 5 or less carbon atoms which is adhered to at least a part of the surface of the particle.

EP2559786 discloses a method comprising:
a) providing a substrate;
b) applying an aqueous catalyst solution to the substrate, the aqueous catalyst solution comprises nanoparticles of one or more metal chosen from silver, gold, platinum, palladium, iridium, copper, aluminum, cobalt, nickel and iron, and one or more stabilizing compounds chosen from gallic acid, gallic acid derivatives and salts thereof, the aqueous catalyst solution is free of tin; and
c) electrolessly depositing metal onto the substrate using an electroless metal plating bath.

U.S. Pat. No. 9,028,724 discloses a method for preparing a dispersion of nanoparticles, comprising: dispersing nanoparticles having hydrophobic ligands on the surface in a hydrophobic solvent to form a first dispersion; mixing the first dispersion with a surface modification solution comprising (a) at least one wetting-dispersing agent selected from polydimethylsilane, alkylol ammonium salt of an acidic polyester and alkylol ammonium salt of a polyacrylic acid, (b) a surfactant, and (c) an aqueous-based solvent to form a first mixture solution; mixing the first mixture solution with a ligand removal agent to form a second mixture solution containing hydrophilic nanoparticles and separating the hydrophilic nanoparticles from the second mixture solution; and dispersing the hydrophilic nanoparticles in an aqueous-based solvent, wherein the nanoparticles comprise one of a metal and a metal oxide.

EP2667990B1 relates to a process comprising:
forming an insoluble complex of a metal salt from a reaction mixture comprising a solvent, a first surfactant, a second surfactant, and a third surfactant, each surfactant being present in the insoluble complex of the metal salt, and
reacting the insoluble complex of the metal salt with a reducing agent in the reaction mixture to form metal nanoparticles;
wherein the first surfactant comprises a primary amine, the second surfactant comprises a secondary amine, and the third surfactant comprises a chelating agent comprising N,N′-dialkylethylenediamine.

EP1791702B9 relates to an ink for ink-jet printing or digital printing comprising a vehicle and metallic particles having a weight average particle size of from 40 nm to 1 micrometres, preferably from 50 nm to 500 nm, wherein the loading of metallic nanoparticles in the ink is comprised between 2 percent by weight and 75 percent by weight, preferably from 2 percent to 40 percent by weight, and the viscosity of the ink is comprised between 10 and 40 cP.

WO09/056401 relates to a method for the synthesis, isolation and re-dispersion in organic matrixes of nano-shaped transition metal particles, selected from the group consisting of Zn, Ag, Cu, Au, Ta, Ni, Pd, Pt, Co, Rh, Ir, Fe, Ru, and Ti, comprising
a) adding to an aqueous solution of the transition metal salt an acrylate or methacrylate monomer or oligomer, or a polyacrylate or polymethacrylate and a reducing agent;
b1) treating the colloidal solution with a peroxide; or
b2) exposing the colloidal solution to UV- or visible light;
c) adding a water soluble amine; and
d) isolating the nano-shaped transition metal particles or re-disperse the nano shaped transition metal particles together with a dispersing agent in a liquid acrylate or methacrylate monomer.

WO2010108837 relates to a method of manufacturing shaped transition metal particles in the form of nanoplatelets, which metal is selected from the group consisting of Cu, Ag, Au, Zn, Cd, Ti, Cr, Mn, Fe, Co, Ni, Ru, Rh, Pd, Os, Ir and Pt, which method comprises the steps of first a) adding a reducing agent to an aqueous mixture comprising a transition metal salt and a polymeric dispersant, and subsequently b) treating the obtained colloidal dispersion with a peroxide, wherein the aqueous mixture in step a) comprises the transition metal salt in a concentration of higher than 2 mmol per liter.

WO11064162 relates to security, or decorative element, comprising a substrate, which may contain indicia or other visible features in or on its surface, and on at least part of the said substrate surface, a coating comprising platelet shaped transition metal particles having a longest dimension of edge length of from 15 nm to 1000 nm, preferably from 15 nm to 600 nm and particularly from 20 nm to 500 nm, and a thickness of from 2 nm to 100 nm, preferably from 2 to 40 nm and particularly from 4 to 30 nm and a method for forming for forming an optically variable image (an optically variable device) on a substrate comprising the steps of: forming an optically variable image (OVI) on a discrete portion of the substrate; and depositing a coating composition comprising platelet shaped transition metal particles having a longest dimension of edge length of from 15 nm to 1000 nm, preferably from 15 nm to 600 nm and particularly from 20 nm to 500 nm, and a thickness of from 2 nm to 100 nm, preferably from 2 to 40 nm and particularly from 4 to 30 nm and a binder on at least a portion of the OVI.

WO2013/186167 discloses a method for forming a surface relief microstructure, especially an optically variable image (an optically variable device, OVD) on a substrate comprising the steps of:
A) applying a curable composition to at least a portion of the substrate wherein the curable composition comprises
a1) at least one ethylenically unsaturated resin, a monomer or a mixture thereof;
a2) at least one photoinitiator; and
a3) a metal pigment which is in the form of platelet shaped transition metal particles having a longest dimension of edge length of from 5 nm to 1000 nm, preferably from 7 nm to 600 nm and particularly from 10 nm to 500 nm, and a thickness of from 1 nm to 100 nm, preferably from 2 to 40 nm and particularly from 3 to 30 nm;
B) contacting at least a portion of the curable composition with a surface relief microstructure, especially optically variable image forming means;
C) curing the composition by using at least one UV lamp.

WO2014/041121 and WO2014/187750 relates to a security elements, comprising a coating comprising platelet shaped transition metal particles having a longest dimension of edge length of from 15 nm to 1000 nm, preferably from 15 nm to 600 nm and particularly from 20 nm to 500 nm, and a thickness of from 2 nm to 100 nm, preferably from 2 to 40 nm and particularly from 4 to 30 nm.

WO2020/083794 relates to compositions, comprising silver nanoplatelets, wherein the mean diameter of the silver nanoplatelets, present in the composition, is in the range of 20 to 70 nm with standard deviation being less than 50% and the mean thickness of the silver nanoplatelets, present in the composition, is in the range of 5 to 30 nm with standard deviation being less than 50%, wherein the mean aspect ratio of the silver nanoplatelets is higher than 1.5, a process for its production, printing inks containing the compositions and their use in security products. The highest wavelength absorption maximum of the population of all silver nanoplatelets in the composition being within the range of 450 to 550 nm. A coating, comprising the composition, shows a red, or magenta color in transmission and a greenish-metallic color in reflection.

WO2020/224982 relates to compositions, comprising silver nanoplatelets, wherein the number mean diameter of the silver nanoplatelets, present in the composition, is in the range of 50 to 150 nm with standard deviation being less than 60% and the number mean thickness of the silver nanoplatelets, present in the composition, is in the range of 5 to 30 nm with standard deviation being less than 50%, wherein the mean aspect ratio of the silver nanoplatelets is higher than 2.0 and the highest wavelength absorption maximum of the population of all silver nanoplatelets in the composition being within the range of 560 to 800 nm. A coating, comprising the composition, shows a blue color in transmission and a metallic yellow color in reflection.

US2022235264 relates to a semiconductor nanoparticle complex comprising a ligand coordinated to a surface of a semiconductor nanoparticle, wherein the semiconductor nanoparticle includes In and P, the ligand includes a mercapto fatty acid ester represented by the following general formula HS—R₁—COOR₂ (1), and the mercapto fatty acid ester has an SP value of 9.30 or less, where R₁ is a C₁₋₁₁hydrocarbon group and R₂ is a C₁₋₃hydrocarbon group). The semiconductor nanoparticle complex keeps high fluorescence quantum yield before and after purification.

WO2022/101207 relates to compositions, comprising silver nanoplatelets capped by dithiocarbamate anions of formula

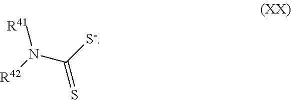

UV-Vis radiation curable inks, containing the silver nanoplatelets, do not degrade and a coating, comprising the composition, shows a blue color in transmission and a metallic yellow color in reflection.

WO2022/101224A1 relates to a UV-Vis radiation curable security ink for producing a security feature for securing value documents, wherein said security feature exhibits a blue color upon viewing in transmitted light and a metallic yellow color upon viewing in incident light. The UV-Vis radiation curable security ink comprises a cationically curable or a hybrid curable ink vehicle, and silver nanoplatelets bearing a surface stabilizing agent of general formula

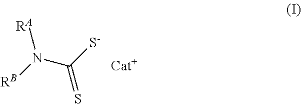

wherein the residue R^{A} is a C₂-C₄alkyl group substituted with a hydroxy group; the residue R^{B} is selected from a C₁-C₄alkyl group, and a C₂-C₄alkyl group substituted with a hydroxy group; and Cat⁺ is a cation selected from the group consisting of Na⁺, K⁺, Cs⁺ and Rb⁺.

WO2022/101225A1 relates to a UV-Vis radiation curable security ink for producing a security feature for securing value documents, wherein said security feature exhibits a blue color upon viewing in transmitted light and a metallic yellow color upon viewing in incident light. The UV-Vis radiation curable security ink comprises a cationically curable or a hybrid curable ink vehicle, and silver nanoplatelets bearing a surface stabilizing agent of general formula

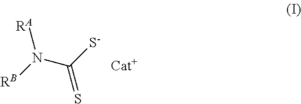

wherein the residue R^{A} is a C₂-C₄alkyl group substituted with a hydroxy group; the residue R^{B} is selected from a C₁-C₄alkyl group, and a C₂-C₄alkyl group substituted with a hydroxy group; and Cat⁺ is an ammonium cation of general formula ⁺NH₂R^{C}R^{D} wherein the residue R^{C} is a C₂-C₄alkyl group substituted with a hydroxy group; and the residue R^{D} is selected from a C₁-C₄alkyl group, and a C₂-C₄alkyl group substituted with a hydroxy group.

WO2022/167377 relates to radically curable compositions, comprising (A) silver nanoplatelets, (B) one reactive diluent comprising 1 to 4 (meth)acrylate groups; (C) one, or more urethane (meth)acrylates (C), which are obtainable by reaction of the following components: (a) at least one isocyanate having two isocyanate groups, (b) at least one polyalkylene oxide polyether having at least 2 hydroxyl groups, (c) at least one hydroxy-functional (meth)acrylate having one hydroxyl group and one (meth)acrylate group, (d) at least one compound having at least one isocyanate reactive group and at least one acid function, (e) if component (d) is present, optionally at least one basic compound which is present for neutralization or partial neutralization of the acid groups of component (d), (f) optionally at least one monoalcohol having one hydroxy function, and (g) optionally at least one compound having at least one primary and/or secondary amino group; (D) one, or more photonitiators; printing inks containing the compositions and their use for the production security products. Coatings obtained after curing of the compositions, show one color, when observed in transmission and another color, when observed in reflection on both sides of the cured coating. The metal-like reflection of the coatings may be further enhanced by the presence of surfactants.

WO2022/238468 relates to compositions, comprising
(A) platelet-shaped transition metal particles, wherein the number mean diameter of the platelet-shaped transition metal particles, present in the composition, is in the range of from 15 nm to 1000 nm, the transition metal is selected from silver, copper, gold and palladium, especially silver and copper, very especially silver;
(B) one, or more reactive diluents (B);
(C) optionally one, or more oligomers (C);
(D) one, or more photonitiators (D);
(E) at least a surfactant (E), which is a block copolymer, comprising at least a block A and a block B, wherein
a) the block A comprises
a1) monomer units (A1) derived from a compound selected from alkyl (meth)acrylates, alkyl (meth)acrylamides, or any mixture thereof, and
a2) monomer units (A2) derived from a hydroxy group, or ether group containing alkyl (meth)acrylate;
b) the block B comprises monomer units (B) derived from a compound selected from fluorinated (meth)acrylic esters of formula

H₂C═CR⁴⁶(C(O)OR_{F-1}) (XX), wherein
R⁴⁶ is H, or a methyl group; and
R_{F-1} is an organic residue containing a perfluorinated alkyl group;
(F) optionally one, or more polymeric binders;
(G) optionally one, or more solvents; and
(H) optionally further additives.

PCT/EP2022/079306 relates to a decorative, or security element and a method for producing the decorative, or security element. The decorative, or security element comprises in this order (a) a substrate; (b) a coating, comprising transition metal particles (A) having a number mean diameter of from 15 nm to 700 nm, wherein the transition metal is selected from silver, copper, gold and palladium, especially silver and copper, very especially silver; (c) optionally a protective coating; wherein the coating (b) is derived from (b1) a solvent based composition, comprising the transition metal particles and a vehicle; and (b2) the coating (b) has a three layer structure: (b2a) a layer, comprising the transition metal particles and a vehicle; (b2b) a layer, comprising the vehicle, which is essentially free of transition metal particles; (b2c) a layer, comprising the transition metal particles and the vehicle. The method comprises the steps of i) applying a solvent based composition comprising transition metal particles and the vehicle; on at least part of the surface of the substrate, and ii) drying the solvent based composition; iii) curing the solvent based composition so as to form the three-layer structure which exhibits intensive angle-dependent colors in reflection on the coating side and/or on the substrate side of the decorative, or security element and a distinctive color in transmission; and
iii) optionally applying a protective coating on the coating (b).

It has now been found, surprisingly, that silver nanoplatelets capped by compounds of formula (XX) have excellent stability of optical properties upon storage or heat exposure and high colloidal stability. Silver nanoplatelets surface-modified in this way can be formulated in screen, rotogravure and flexography printing inks, which upon printing exhibit blue color in transmission and metallic yellow color in reflection and show excellent shelf stability.

Accordingly, the present application relates to compositions, comprising silver nanoplatelets, wherein the silver nanoplatelets are capped by a compound of formula

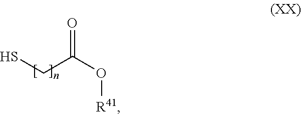

wherein
R⁴¹ is a C₄-C₂₅alkyl group, which may be interrupted by one, or more oxygen atoms, and/or C═C double bonds, and n is a number 1 to 10.
R⁴¹ is a C₄-C₂₅alkyl group, preferably a C₁₀-C₂₅alkyl group, more preferably a C₁₂-C₁₈alkyl group.
n is especially 1 to 6, very especially 1, 2 or 3.

The compound of formula (XX) is preferably selected from HS(CH₂)₂C(C═O)O(CH₂)₁₇CH₃ (E-1), HS(CH₂)₂C(C═O)O(CH₂)₁₆CH₃ (E-2), HS(CH₂)₂C(C═O)O(CH₂)₁₅CH₃ (E-3), HS(CH₂)₂C(C═O)O(CH₂)₁₄CH₃ (E-4), HS(CH₂)₂C(C═O)O(CH₂)₁₃CH₃ (E-5), HS(CH₂)₂C(C═O)O(CH₂)₁₂CH₃ (E-6), HS(CH₂)₂C(C═O)O(CH₂)₁₁CH₃ (E-7), HS(CH₂)₂C(C═O)O(CH₂)₁₀CH₃ (E-8), HSCH₂C(C═O)O(CH₂)₁₇CH₃ (E-9), HSCH₂C(C═O)O(CH₂)₁₆CH₃ (E-10), HSCH₂C(C═O)O(CH₂)₁₅CH₃ (E-11), HSCH₂C(C═O)O(CH₂)₁₄CH₃ (E-12), HSCH₂C(C═O)O(CH₂)₁₃CH₃ (E-13), HSCH₂C(C═O)O(CH₂)₁₂CH₃ (E-14), HSCH₂C(C═O)O(CH₂)₁₁CH₃ (E-15), HSCH₂C(C═O)O(CH₂)₁₀CH₃ (E-16), HS(CH₂)₃C(C═O)O(CH₂)₁₇CH₃ (E-17), HS(CH₂)₃C(C═O)O(CH₂)₁₆CH₃ (E-18), HS(CH₂)₃C(C═O)O(CH₂)₁₅CH₃ (E-19), HS(CH₂)₃C(C═O)O(CH₂)₁₄CH₃ (E-20), HS(CH₂)₃C(C═O)O(CH₂)₁₃CH₃ (E-21), HS(CH₂)₃C(C═O)O(CH₂)₁₂CH₃ (E-22), HS(CH₂)₃C(C═O)O(CH₂)₁₁CH₃ (E-23), HS(CH₂)₃C(C═O)O(CH₂)₁₀CH₃ (E-24) and mixtures thereof.

Usually the cpd. of formula (XX) is used in amount of 0.01 to 20% by weight, preferably 0.1 to 10% by weight, more preferably 0.5 to 7, especially 0.5 to 6% based on the amount of Ag nanoplatelets.

The capping with the compound of formula (XX) renders the surface on the nanoparticles more hydrophobic, while maintaining colloidal stability of their dispersions in organic solvents and/or monomer compositions. This combination of properties allows for production of stable UV curable coating/printing compositions, suitable for manufacture of dichroic security elements for protection of value documents. The surface modification, described in the present invention is suitable for silver nanoplatelets of different sizes and, correspondingly, colors, and is especially useful for manufacture of solvent-free coating, or printing compositions.

In principle, any type of silver nanoparticles can be capped by compounds of formula (XX). It is preferred that the silver nanoparticles are anisotropic (non-spherical). Most preferred are silver nanoplatelets. The silver nanoplatelets may be in the form of disks, regular hexagons, triangles, especially equilateral triangles, and truncated triangles, especially truncated equilateral triangles, or mixtures thereof. They are preferably in the form of disks, truncated triangles, hexagons, or mixtures thereof.

The term “silver nanoplatelets” is a term used in the art and as such is understood by the skilled person. In the context of the present invention, silver nanoplatelets are platelet shaped silver particles having a number mean diameter (maximum Feret diameter) in the range of 15 to 600 nm and a number mean thickness in the range of 2 to 100 nm. The mean aspect ratio being higher than 1.5. Preferred silver nanoplatelets are, for example, silver nanoplatelets having a number mean diameter in the range of 50 to 100 nm and a number mean thickness in the range of 5 to 30 nm, silver nanoplatelets having a number mean diameter in the range of 20 to 70 nm and a number mean thickness in the range of 5 to 30 nm, or silver nanoplatelets having a number mean diameter in the range of 15 to 35 nm and a number mean thickness in the range of 5 to 20 nm, The mean aspect ratio being higher than 1.5.

In the context of the present invention, a “surface modified silver nanoplatelet (nanoparticle)” is a silver nanoplatelet (nanoparticle) having attached to its surface one or more (surface) stabilizing agents.

Accordingly, the present invention relates to surface modified silver nanoplatelets capped by compounds of formula (XX) and optionally bearing further surface stabilizing agent(s) and further stabilizing agents described below on their surface.

In one embodiment the present invention the mean diameter of the silver nanoplatelets, present in the composition, is in the range of 50 to 100 nm, preferably 50 to 90 nm, more preferably 55 to 80 nm. The standard deviation being preferably less than 60%, more preferred less than 50%.

The diameter of a silver nanoplatelet is the longest dimension of said silver nanoplatelet and corresponds to the maximum dimension of said silver nanoplatelet when oriented parallel to the plane of a transmission electron microscopy (TEM) image. As used herein, the term “number mean diameter of the silver nanoplatelets” refers to the mean diameter determined by transmission electron microscopy (TEM) using Fiji image analysis software (or Image analysis software: ParticleSizer (Thorsten Wagner (2016) ij-particlesizer: ParticleSizer 1.0.9. Zenodo; 10.5281/zenodo.820296) and ImageJ version 1.53f51) based on the measurement of at least 300, especially at least 500 randomly selected silver nanoplatelets oriented parallel to the plane of a transmission electron microscopy image (TEM), wherein the diameter of a silver nanoplatelet is the maximum dimension (maximum Feret diameter) of said silver nanoplatelet oriented parallel to the plane of a transmission electron microscopy (TEM) image. TEM analysis was conducted on a dispersion containing silver nanoplatelets in isopropanol using an EM 910 instrument from ZEISS (INST.109) in bright field mode at an e-beam acceleration voltage of 100 kV.

The number mean thickness of the silver nanoplatelets is in the range of 5 to 30 nm, preferably 7 to 25 nm, more preferably 8 to 25 nm. The standard deviation being preferably less than 50%, more preferred less than 30%.

The thickness of a silver nanoplatelet is the shortest dimension of said nanoplatelet and corresponds to the maximum thickness of said silver nanoplatelet. As used herein, the term “number mean thickness of silver nanoplatelets” refers to the mean thickness determined by transmission electron microscopy (TEM) based on the measurement of at least 50, especially of at least 300 randomly selected silver nanoplatelets oriented perpendicular to the plane of the TEM image, wherein the thickness of the silver nanoplatelet is the maximum thickness of said silver nanoplatelet. TEM analysis was conducted on a dispersion containing silver nanoplatelets in isopropanol using an EM 910 instrument from ZEISS (INST.109) in bright field mode at an e-beam acceleration voltage of 100 kV.

The thickness of at least 300 randomly selected silver nanoplatelets may be determined from the cross-sectional TEM images by fitting ellipses to the cross-sectioned particles by the software (ParticleSizer). The minor axis (the shortest diameter) of the fitted ellipse is taken as particle thickness.

The diameter is the longer side of the nanoplatelet (width). The thickness is the shorter side of the nanoplatelet (height).

The mean aspect ratio (defined as the ratio of number mean diameter to number mean thickness) being larger than 1.7, preferably larger than 1.8 and more preferably larger than 1.9.

The aspect ratio of the nanoplatelets is the ratio of its longest dimension, such as, for example, its diameter to its shortest dimension, such as, for example, its thickness. For example, the aspect ratio of a disk is the ratio of its diameter to its thickness.

In a particularly preferred embodiment the number mean diameter of the silver nanoplatelets is in the range of 55 to 80 nm with standard deviation being preferably less than 50% and the number mean thickness of the silver nanoplatelets is in the range of 8 to 25 nm with standard deviation being preferably less than 30%. The mean aspect ratio of the silver nanoplatelets is higher than 1.9 (a coating, comprising the silver nanoplatelets, shows a turquoise, or blue color in transmission and a yellowish metallic color in reflection).

The highest wavelength absorption maximum of the population of all silver nanoplatelets in the composition being within the range of 540 to 700 nm, preferably 550 to 650 nm, most preferably 550 to 630 nm (measured in water at ca. 5*10-5 M (mol/1) concentration of silver).

The absorption maximum has a full width at half maximum (FWHM) value in the range of 70 to 200 nm, preferably 75 to 180 nm, more preferably 80 to 150 nm.

The molar extinction coefficient of silver nanoplatelets, measured at the highest wavelength absorption maximum of the population of all silver nanoplatelets in the composition, is higher than 4000 L/(cm*mol_{Ag}), especially higher than 5000 L/(cm*mol_{Ag}), very especially higher than 8000 L/(cm*mol_{Ag}).

The silver nanoplatelets are capped by a compound of formula (XX).

Accordingly, the present invention relates to compositions, comprising silver nanoplatelets, wherein the silver nanoplatelets are capped by a compound of formula (XX).

In addition to the capping agent(s) of formula (XX) the composition may comprise one, or more surface stabilizing agent(s).

In a preferred embodiment of the present invention the silver nanoplatelets bear a surface stabilizing agent of formula

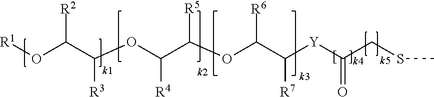

on their surface, wherein [symbol] indicates the bond to the silver,
R¹ is H, C₁-C₁₈alkyl, phenyl, C₁-C₈alkylphenyl, or CH₂COOH;
R², R³, R⁴, R⁵, R⁶ and R⁷ are independently of each other H, C₁-C₈alkyl, or phenyl;
Y is O, or NR⁸;
R⁸ is H, or C₁-C₈alkyl;
k1 is an integer in the range of from 1 to 500,
k2 and k3 are independently of each other 0, or integers in the range of from 1 to 250;
k4 is 0, or 1,
k5 is an integer in the range of from 1 to 5.

Y is preferably O. k4 is preferably 0.

The surface stabilizing agent of formula (I) has preferably a number average molecular weight of from 1000 to 20000, and more preferably from 1000 to 10000, most preferred from 1000 to 6000. All molecular weights specified in this text have the unit of [g/mol] and refer, unless indicated otherwise, to the number average molecular weight (Mn).

If the compounds comprise, for example, ethylene oxide units (EO) and propylene oxide units (PO), the order of (EO) and (PO) may be fixed (block copolymers), or may not be fixed (random copolymers).

Preferably, R¹ is H, or C₁-C₁₈alkyl; R², R³, R⁴, R⁵, R⁶ and R⁷ are independently of each other H, CH₃, or C₂H₅; k1 is 22 to 450, k2 and k3 are independently of each other 0, or integers in the range of from 1 to 250; k4 is 0, or 1; and k5 is an integer in the range of from 1 to 5.

More preferred, R¹ is H, or C₁-C₄alkyl; R², R³, R⁴, R⁵, R⁶ and R⁷ are independently of each other H, or CH₃; k1 is 22 to 450; k2 and k3 are independently of each other 0, or integers in the range of from 1 to 100; k4 is 0; k5 is an integer in the range of from 1 to 4.

The most preferred surface stabilizing agent has the formula

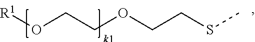

wherein R¹ is H, or a C₁-C₈alkyl group, and k1 is 22 to 450, especially 22 to 150.

R¹ is preferably H, or CH₃.

The preferred surface stabilizing agents are derived from MPEG thiols (poly(ethylene glycol) methyl ether thiols) having an average Mₙ of 2000 to 6000, such as, for example, MPEG 2000 thiol (A-1, average Mₙ 2,000), MPEG 3000 thiol (A-2), MPEG 4000 thiol (A-3) MPEG 5000 thiol (A-4), MPEG 6000 thiol (A-5), PEG thiols (0-(2-mercaptoethyl)-poly(ethylene glycol)) having an average Mₙ of 2000 to 6000, such as, for example, PEG 2000 thiol (A-6, average Mₙ 2,000), PEG 3000 thiol (A-7), PEG 4000 thiol (A-8), PEG 5000 thiol (A-9), PEG 6000 thiol (A-10).

Usually the compound of formula (I) is present on the surface of Ag nanoplatelets in amount of 0.01 to 20% by weight, preferably 0.1 to 15% by weight, more preferably 0.5 to 13% by weight, especially, 2 to 10% by weight based on the amount of Ag nanoplatelets.

In addition to the surface stabilizing agents the composition may comprise further stabilizing agents.

The stabilizing agent may be a compound of formula

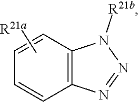

wherein
R^{21a} is a hydrogen atom, a halogen atom, a C₁-C₈alkoxy group, or a C₁-C₈alkyl group,
R^{21b} is a hydrogen atom, or a group of formula —CHR²⁴—N(R²²)(R²³),
R²² and R²³ are independently of each other a C₁-C₈alkyl, a hydroxyC₁-C₈alkyl group, or a group of formula —[(CH₂CH₂)—O]ₙ₁—CH₂CH₂—OH, wherein n1 is 1 to 5, R²⁴ is H or C₁-C₈alkyl.

Examples of compounds of formula (IIb) are

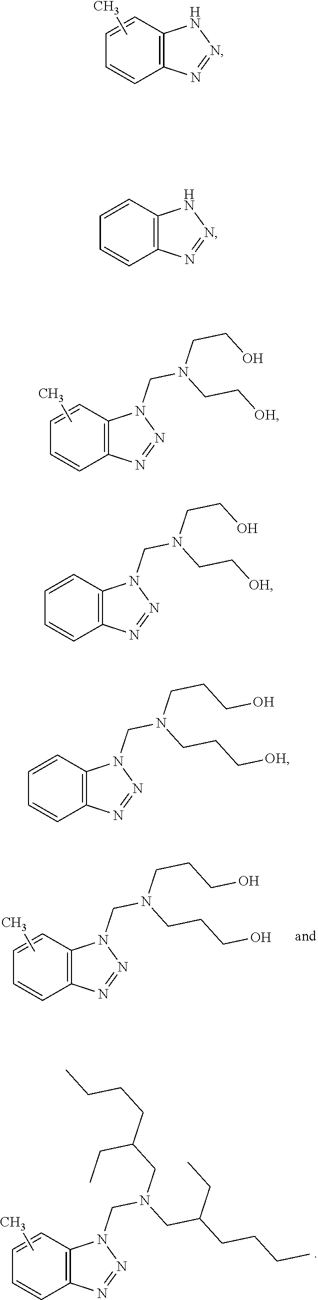

Usually the cpd. of formula (IIb) is used in amount of 0 to 10% by weight, preferably 0.05 to 7% by weight, more preferably 0.1 to 6, especially 0.2 to 5% based on the amount of Ag nanoplatelets.

In another preferred embodiment the stabilizing agent is a “polyhydric phenol”, which is a compound, containing an optionally substituted benzene ring and at least 2 hydroxy groups attached to it. The term “polyhydric phenol” comprises polyphenols, such as, for example, tannic acid and polycyclic aromatic hydrocarbons which consist of fused benzene rings, wherein at least one benzene ring has at least 2 hydroxy groups attached to it, such as, for example, 1,2-dihydroxynaphthalene. The “polyhydric phenol” may be substituted. Suitable substituents are described below.

The polyhydric phenol is preferably a compound of formula

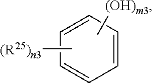

wherein R²⁵ can be the same, or different in each occurrence and is a hydrogen atom, a halogen atom, a C₁-C₁₈alkyl group, a C₁-C₁₈alkoxy group, or a group —C(═O)—R²⁶, R²⁶ is a hydrogen atom, a hydroxy group, a C₁-C₁₈alkyl group, unsubstituted or substituted amino group, unsubstituted or substituted phenyl group, or a C₁-C₁₈alkoxy group, and
n3 is a number of 1 to 4,
m3 is a number of 2 to 4, and
the sum of m3 and n3 is 6.

The polyhydric phenol is more preferably a compound of formula

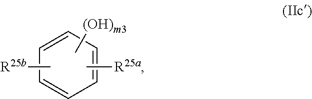

wherein
R^{25a} and R^{25b} are independently of each other a hydrogen atom, a C₁-C₁₈alkyl group, a C₁-C₁₆alkoxy group, or a group of formula —C(═O)—R²⁶,
R²⁶ is a hydrogen atom, a hydroxy group, a C₁-C₁₈alkyl group, an unsubstituted or substituted amino group, unsubstituted or substituted phenyl group, or a C₁-C₁₈alkoxy group, and
m3 is a number of 2 to 4, especially 2 to 3. Polyhydric phenols are preferred, which have two hydroxy groups in ortho-position.

The polyhydric phenol is even more preferably a compound of formula

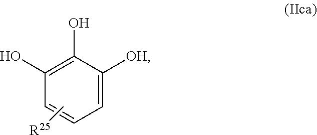

wherein R²⁵ is a hydrogen atom, or a group of formula —C(═O)—R²⁶, wherein R²⁶ is a hydrogen atom, a C₁-C₁₈alkyl group, or a C₁-C₁₈alkoxy group, an unsubstituted or substituted amino group, especially a C₁-C₁₈alkyl group or C₁-C₈alkoxy group, in particular a compound of formula

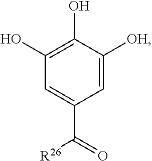

wherein R²⁶ is a hydrogen atom, a C₁-C₁₈alkyl group, or a C₁-C₁₈alkoxy group, especially a C₁-C₈alkoxy group, such as, for example,

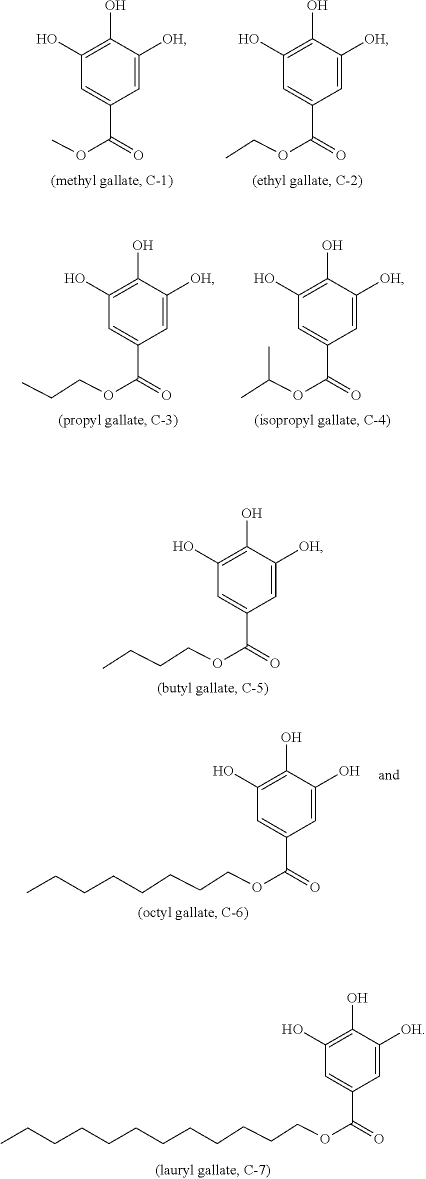

In another preferred embodiment of the present invention the polyhydric phenols are compounds of formula

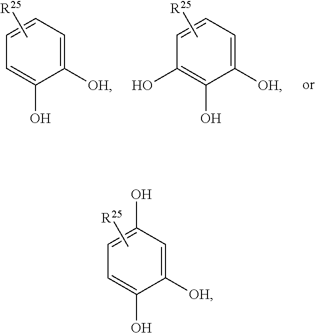

wherein R²⁵ is a hydrogen atom, a C₁-C₁₈alkyl group, or a group of formula-C(═O)—R²⁶, wherein R²⁶ is a hydrogen atom, a hydroxy group, a C₁-C₁₈alkyl group, or a C₁-C₁₈alkoxy group, an unsubstituted or substituted amino group, an unsubstituted or substituted phenyl group, especially a C₁-C₁₈alkyl group, C₁-C₈alkoxy group, or phenyl group, such as, for example,

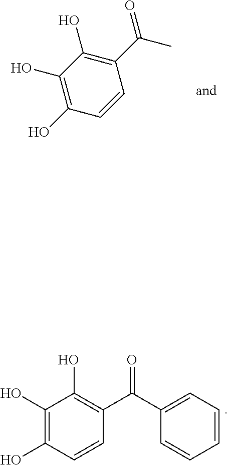 [SMILES: CC(=O)c1ccc(O)c(O)c1O ; O=C(c1ccccc1)c1ccc(O)c(O)c1O]

Usually the cpd. of formula (IIc) is used in amount of 0 to 20% by weight, preferably 0.05 to 10% by weight, more preferably 0.1 to 8, especially 1 to 7% based on the amount of Ag nanoplatelets.

An unsubstituted or substituted amino group is, for example, a group of formula —NR²⁷R²⁸, wherein R²⁷ and R²⁸ are independently of each other a hydrogen atom, a C₁-C₁₈alkyl group, a phenyl group, preferably a hydrogen atom, or a C₁-C₁₈alkyl group.

In a particularly preferred embodiment the stabilizing agent is selected from compounds of formula (IIb), (IIc), or mixtures thereof.

In a particularly preferred embodiment the silver nanoplatelets comprise one, or more surface stabilizing agents of formula (I) and one, or more surface stabilizing agents of formula (IIc). In addition, the silver nanoplatelets may comprise one, or more stabilizing agents of formula (IIb).

The most preferred (surface) stabilizing agents (surface stabilizing agents and stabilizing agents), or combinations thereof for silver nanoplatelets having a number mean diameter in the range of from 55 to 80 nm with standard deviation being preferably less than 50% and a mean thickness in the range of from 8 to 25 nm with standard deviation being preferably less than 30%, wherein the mean aspect ratio of the silver nanoplatelets is higher than 1.9; are shown in the below table.

| | Compound | Compound | Compound | Compound |
|---|---|---|---|---|
| | of formula | of formula | of formula | of formula |
| | (I) | (IIb) | (IIc) | (XX) |
| SA-1 | A-6 | B-1 | C-9 | E-1 |
| SA-2 | A-6 | B-2 | C-9 | E-1 |
| SA-3 | A-6 | B-3 | C-9 | E-1 |
| SA-4 | A-6 | B-4 | C-9 | E-1 |
| SA-5 | A-6 | B-7 | C-9 | E-1 |
| SA-6 | A-7 | B-1 | C-9 | E-1 |
| SA-7 | A-7 | B-2 | C-9 | E-1 |
| SA-8 | A-7 | B-3 | C-9 | E-1 |
| SA-9 | A-7 | B-4 | C-9 | E-1 |
| SA-10 | A-7 | B-7 | C-9 | E-1 |
| SA-11 | A-8 | B-1 | C-9 | E-1 |
| SA-12 | A-8 | B-2 | C-9 | E-1 |
| SA-13 | A-8 | B-3 | C-9 | E-1 |
| SA-14 | A-8 | B-4 | C-9 | E-1 |
| SA-15 | A-8 | B-7 | C-9 | E-1 |
| SA-16 | A-6 | B-1 | C-7 | E-1 |
| SA-17 | A-6 | B-2 | C-7 | E-1 |
| SA-18 | A-6 | B-3 | C-7 | E-1 |
| SA-19 | A-6 | B-4 | C-7 | E-1 |
| SA-20 | A-6 | B-7 | C-7 | E-1 |
| SA-21 | A-7 | B-1 | C-7 | E-1 |
| SA-22 | A-7 | B-2 | C-7 | E-1 |
| SA-23 | A-7 | B-3 | C-7 | E-1 |
| SA-24 | A-7 | B-4 | C-7 | E-1 |
| SA-25 | A-7 | B-7 | C-7 | E-1 |
| SA-26 | A-8 | B-1 | C-7 | E-1 |
| SA-27 | A-8 | B-2 | C-7 | E-1 |
| SA-28 | A-8 | B-3 | C-7 | E-1 |
| SA-29 | A-8 | B-4 | C-7 | E-1 |
| SA-30 | A-8 | B-7 | C-7 | E-1 |
| SA-31 | A-6 | B-1 | C-9 | E-3 |
| SA-32 | A-6 | B-2 | C-9 | E-3 |
| SA-33 | A-6 | B-3 | C-9 | E-3 |
| SA-34 | A-6 | B-4 | C-9 | E-3 |
| SA-35 | A-6 | B-7 | C-9 | E-3 |
| SA-36 | A-7 | B-1 | C-9 | E-3 |
| SA-37 | A-7 | B-2 | C-9 | E-3 |
| SA-38 | A-7 | B-3 | C-9 | E-3 |
| SA-39 | A-7 | B-4 | C-9 | E-3 |
| SA-40 | A-7 | B-7 | C-9 | E-3 |
| SA-41 | A-8 | B-1 | C-9 | E-3 |
| SA-42 | A-8 | B-2 | C-9 | E-3 |
| SA-43 | A-8 | B-3 | C-9 | E-3 |
| SA-44 | A-8 | B-4 | C-9 | E-3 |
| SA-45 | A-8 | B-7 | C-9 | E-3 |
| SA-46 | A-6 | B-1 | C-7 | E-3 |
| SA-47 | A-6 | B-2 | C-7 | E-3 |
| SA-48 | A-6 | B-3 | C-7 | E-3 |
| SA-49 | A-6 | B-4 | C-7 | E-3 |
| SA-50 | A-6 | B-7 | C-7 | E-3 |
| SA-51 | A-7 | B-1 | C-7 | E-3 |
| SA-52 | A-7 | B-2 | C-7 | E-3 |
| SA-53 | A-7 | B-3 | C-7 | E-3 |
| SA-54 | A-7 | B-4 | C-7 | E-3 |
| SA-55 | A-7 | B-7 | C-7 | E-3 |
| SA-56 | A-8 | B-1 | C-7 | E-3 |
| SA-57 | A-8 | B-2 | C-7 | E-3 |
| SA-58 | A-8 | B-3 | C-7 | E-3 |
| SA-59 | A-8 | B-4 | C-7 | E-3 |
| SA-60 | A-8 | B-7 | C-7 | E-3 |

In another preferred embodiment the present application relates to compositions, comprising silver nanoplatelets, which bear a surface stabilizing agent of formula (XX) and optionally further stabilizing agents described below on their surface, wherein the mean diameter of the silver nanoplatelets, present in the composition, is in the range of 20 to 70 nm, especially 30 to 60 nm and the mean thickness of the silver nanoplatelets, present in the composition, is preferably in the range of 5 to 30 nm (a coating, comprising the silver nanoplatelets, shows a magenta color in transmission and a greenish metallic color in reflection).

The mean aspect ratio of the silver nanoplatelets is preferably higher than 1.5.

The number mean diameter of the silver nanoplatelets and is in the range of 20 to 70 nm, preferably 30 to 60 nm, more preferably 35 to 55 nm, most preferred 37 to 52 nm. The standard deviation being less than 50%, preferably less than 40%.

The mean thickness of the silver nanoplatelets is the number mean thickness of the silver nanoplatelets and is in the range of 5 to 30 nm, preferably 7 to 25 nm, more preferably 8 to 25 nm. The standard deviation being less than 50%, preferably less than 40%.

The mean aspect ratio being larger than 1.5, preferably larger than 1.6 and more preferably larger than 1.7.

In an even more preferred embodiment the number mean diameter of the silver nanoplatelets is in the range of 35 to 55 nm with standard deviation being less than 40% and the mean thickness of the silver nanoplatelets is in the range of 8 to 25 nm with standard deviation being less than 40%. The mean aspect ratio of the silver nanoplatelets is higher than 1.7.

The highest wavelength absorption maximum of the population of all silver nanoplatelets in the composition being within the range of 450 to 550 nm, preferably 460 to 540 nm, most preferably 465 to 535 nm (measured in water at ca. 5*10-5 M (mol/1) concentration of silver).

The absorption maximum has a full width at half maximum (FWHM) value in the range of 20 to 180 nm, preferably 30 to 150 nm, more preferably 35 to 130 nm.

In a particularly preferred embodiment the mean diameter of the silver nanoplatelets is in the range of 40 to 50 nm with standard deviation being less than 30% and the mean thickness of the silver nanoplatelets is in the range of 15 to 22 nm with standard deviation being less than 30%. The mean aspect ratio of the silver nanoplatelets is higher than 1.7.

In said embodiment the highest wavelength absorption maximum of the population of all silver nanoplatelets in the composition being within the range of 480 to 500 nm (measured in water at ca. 5*10-5 M (mol/l) concentration of silver). The absorption maximum has a full width at half maximum (FWHM) value in the range of 70 to 95 nm.

The molar extinction coefficient of silver nanoplatelets, measured at the highest wavelength absorption maximum of the population of all silver nanoplatelets in the composition, is higher than 4000 L/(cm*mol_{Ag}), especially higher than 5000 L/(cm*mol_{Ag}), very especially higher than 6000 L/(cm*mol_{Ag}).

In addition to the capping agent(s) of formula (XX) the composition may comprise one, or more surface stabilizing agent(s).

In a preferred embodiment of the present invention the silver nanoplatelets bear a surface stabilizing agent of formula (I), especially a compound (A-1), (A-2), (A-3), (A-4), (A-5), (A-6), (A-7), (A-8), (A-9), (A-10), or mixtures thereof, very especially a compound (A-7). With respect to the surface stabilizing agent of formula (I) the preferences described above apply.

In addition to the surface stabilizing agents the composition may comprise further stabilizing agents, especially a compound of formula (IIb) and/or a compound of formula (IIc). With respect to the compound of formula (IIb) and (IIc) the preferences described above apply. In a particularly preferred embodiment the stabilizing agent is selected from compounds of formula (IIb), especially a compound (B-1), (B-2), (B-3), (B-4), (B-5), (B-6), or (B-7), very especially a compound (B-1), or (B-3); (IIc), especially a compound (C-1), (C-2), (C-3), (C-4), (C-5), (C-6), (C-7), (C-8), or (C-9), very especially a compound (C-9); and mixtures thereof.

The most preferred (surface) stabilizing agents (surface stabilizing agents and stabilizing agents), or mixtures thereof in said embodiment for silver nanoplatelets having a number mean diameter in the range of from 35 to 65 nm with standard deviation being less than 40% and a mean thickness in the range of from 8 to 25 nm with standard deviation being less than 40%, wherein the mean aspect ratio of the silver nanoplatelets is higher than 1.7; are shown in the below table.

| | Compound | Compound | Compound | Compound |
|---|---|---|---|---|
| | of formula | of formula | of formula | of formula |
| | (I) | (IIb) | (IIc) | (XX) |
| SB-1 | A-6 | B-1 | C-9 | E-1 |
| SB-2 | A-6 | B-2 | C-9 | E-1 |
| SB-3 | A-6 | B-3 | C-9 | E-1 |
| SB-4 | A-6 | B-4 | C-9 | E-1 |
| SB-5 | A-6 | B-7 | C-9 | E-1 |
| SB-6 | A-7 | B-1 | C-9 | E-1 |
| SB-7 | A-7 | B-2 | C-9 | E-1 |
| SB-8 | A-7 | B-3 | C-9 | E-1 |
| SB-9 | A-7 | B-4 | C-9 | E-1 |
| SB-10 | A-7 | B-7 | C-9 | E-1 |
| SB-11 | A-8 | B-1 | C-9 | E-1 |
| SB-12 | A-8 | B-2 | C-9 | E-1 |
| SB-13 | A-8 | B-3 | C-9 | E-1 |
| SB-14 | A-8 | B-4 | C-9 | E-1 |
| SB-15 | A-8 | B-7 | C-9 | E-1 |
| SB-16 | A-6 | B-1 | C-7 | E-1 |
| SB-17 | A-6 | B-2 | C-7 | E-1 |
| SB-18 | A-6 | B-3 | C-7 | E-1 |
| SB-19 | A-6 | B-4 | C-7 | E-1 |
| SB-20 | A-6 | B-7 | C-7 | E-1 |
| SB-21 | A-7 | B-1 | C-7 | E-1 |
| SB-22 | A-7 | B-2 | C-7 | E-1 |
| SB-23 | A-7 | B-3 | C-7 | E-1 |
| SB-24 | A-7 | B-4 | C-7 | E-1 |
| SB-25 | A-7 | B-7 | C-7 | E-1 |
| SB-26 | A-8 | B-1 | C-7 | E-1 |
| SB-27 | A-8 | B-2 | C-7 | E-1 |
| SB-28 | A-8 | B-3 | C-7 | E-1 |
| SB-29 | A-8 | B-4 | C-7 | E-1 |
| SB-30 | A-8 | B-7 | C-7 | E-1 |
| SB-31 | A-6 | B-1 | C-9 | E-3 |
| SB-32 | A-6 | B-2 | C-9 | E-3 |
| SB-33 | A-6 | B-3 | C-9 | E-3 |
| SB-34 | A-6 | B-4 | C-9 | E-3 |
| SB-35 | A-6 | B-7 | C-9 | E-3 |
| SB-36 | A-7 | B-1 | C-9 | E-3 |
| SB-37 | A-7 | B-2 | C-9 | E-3 |
| SB-38 | A-7 | B-3 | C-9 | E-3 |
| SB-39 | A-7 | B-4 | C-9 | E-3 |
| SB-40 | A-7 | B-7 | C-9 | E-3 |
| SB-41 | A-8 | B-1 | C-9 | E-3 |
| SB-42 | A-8 | B-2 | C-9 | E-3 |
| SB-43 | A-8 | B-3 | C-9 | E-3 |
| SB-44 | A-8 | B-4 | C-9 | E-3 |
| SB-45 | A-8 | B-7 | C-9 | E-3 |
| SB-46 | A-6 | B-1 | C-7 | E-3 |
| SB-47 | A-6 | B-2 | C-7 | E-3 |
| SB-48 | A-6 | B-3 | C-7 | E-3 |
| SB-49 | A-6 | B-4 | C-7 | E-3 |
| SB-50 | A-6 | B-7 | C-7 | E-3 |
| SB-51 | A-7 | B-1 | C-7 | E-3 |
| SB-52 | A-7 | B-2 | C-7 | E-3 |
| SB-53 | A-7 | B-3 | C-7 | E-3 |
| SB-54 | A-7 | B-4 | C-7 | E-3 |
| SB-55 | A-7 | B-7 | C-7 | E-3 |
| SB-56 | A-8 | B-1 | C-7 | E-3 |
| SB-57 | A-8 | B-2 | C-7 | E-3 |
| SB-58 | A-8 | B-3 | C-7 | E-3 |
| SB-59 | A-8 | B-4 | C-7 | E-3 |
| SB-60 | A-8 | B-7 | C-7 | E-3 |

In another particularly preferred embodiment the mean diameter of the silver nanoplatelets is in the range of 15 to 35 nm and the mean thickness of the silver nanoplatelets is in the range of 5 to 20 nm. The mean aspect ratio of the silver nanoplatelets is higher than 1.5 (a coating, comprising the silver nanoplatelets, shows a yellow, brown, or orange color in transmission and a blueish metallic color in reflection).

In said embodiment the highest wavelength absorption maximum of the population of all silver nanoplatelets in the composition being within the range of 420 to 460 nm (measured in water at ca. 5*10-5 M (mol/1) concentration of silver). The absorption maximum has a full width at half maximum (FWHM) value in the range of 20 to 80 nm.

In said embodiment the silver nanoplatelets preferably bear a surface stabilizing agent of formula

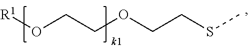

wherein R¹ is H, or a C₁-C₈alkyl group, especially H, or CH₃, and
k1 is 22 to 450, especially 22 to 150; especially a compound (A-1), (A-2), (A-3), (A-4), (A-5), (A-6), (A-7), (A-8), (A-9), (A-10), or mixtures thereof, very especially a compound (A-7), or (A-8).

In said embodiment the silver nanoplatelets preferably bear a stabilizing agent of formula (IIb) and optionally a stabilizing agent of formula (IIc). The stabilizing agent of formula (IIb) is especially a compound (B-1), (B-2), (B-3), (B-4), (B-5), (B-6), or (B-7), very especially a compound (B-1), or (B-3). The stabilizing agent of formula (IIc) is especially a compound (C-1), (C-2), (C-3), (C-4), (C-5), (C-6), (C-7), (C-8), or (C-9), very especially a compound (C-9).

The most preferred (surface) stabilizing agents (surface stabilizing agents and stabilizing agents), or mixtures thereof in said embodiment for silver nanoplatelets having a number mean diameter in the range of from 15 to 35 nm and a mean thickness in the range of from 5 to 20 nm, wherein the mean aspect ratio of the silver nanoplatelets is higher than 1.5; are shown in the below table.

| | Compound | Compound | Compound | Compound |
|---|---|---|---|---|
| | of formula | of formula | of formula | of formula |
| | (I) | (IIb) | (IIc) | (XX) |
| SC-1 | A-6 | B-1 | C-9 | E-1 |
| SC-2 | A-6 | B-2 | C-9 | E-1 |
| SC-3 | A-6 | B-3 | C-9 | E-1 |
| SC-4 | A-6 | B-4 | C-9 | E-1 |
| SC-5 | A-6 | B-7 | C-9 | E-1 |
| SC-6 | A-7 | B-1 | C-9 | E-1 |
| SC-7 | A-7 | B-2 | C-9 | E-1 |
| SC-8 | A-7 | B-3 | C-9 | E-1 |
| SC-9 | A-7 | B-4 | C-9 | E-1 |
| SC-10 | A-7 | B-7 | C-9 | E-1 |
| SC-11 | A-8 | B-1 | C-9 | E-1 |
| SC-12 | A-8 | B-2 | C-9 | E-1 |
| SC-13 | A-8 | B-3 | C-9 | E-1 |
| SC-14 | A-8 | B-4 | C-9 | E-1 |
| SC-15 | A-8 | B-7 | C-9 | E-1 |
| SC-16 | A-6 | B-1 | C-7 | E-1 |
| SC-17 | A-6 | B-2 | C-7 | E-1 |
| SC-18 | A-6 | B-3 | C-7 | E-1 |
| SC-19 | A-6 | B-4 | C-7 | E-1 |
| SC-20 | A-6 | B-7 | C-7 | E-1 |
| SC-21 | A-7 | B-1 | C-7 | E-1 |
| SC-22 | A-7 | B-2 | C-7 | E-1 |
| SC-23 | A-7 | B-3 | C-7 | E-1 |
| SC-24 | A-7 | B-4 | C-7 | E-1 |
| SC-25 | A-7 | B-7 | C-7 | E-1 |
| SC-26 | A-8 | B-1 | C-7 | E-1 |
| SC-27 | A-8 | B-2 | C-7 | E-1 |
| SC-28 | A-8 | B-3 | C-7 | E-1 |
| SC-29 | A-8 | B-4 | C-7 | E-1 |
| SC-30 | A-8 | B-7 | C-7 | E-1 |
| SC-31 | A-6 | B-1 | C-9 | E-3 |
| SC-32 | A-6 | B-2 | C-9 | E-3 |
| SC-33 | A-6 | B-3 | C-9 | E-3 |
| SC-34 | A-6 | B-4 | C-9 | E-3 |
| SC-35 | A-6 | B-7 | C-9 | E-3 |
| SC-36 | A-7 | B-1 | C-9 | E-3 |
| SC-37 | A-7 | B-2 | C-9 | E-3 |
| SC-38 | A-7 | B-3 | C-9 | E-3 |
| SC-39 | A-7 | B-4 | C-9 | E-3 |
| SC-40 | A-7 | B-7 | C-9 | E-3 |
| SC-41 | A-8 | B-1 | C-9 | E-3 |
| SC-42 | A-8 | B-2 | C-9 | E-3 |
| SC-43 | A-8 | B-3 | C-9 | E-3 |
| SC-44 | A-8 | B-4 | C-9 | E-3 |
| SC-45 | A-8 | B-7 | C-9 | E-3 |
| SC-46 | A-6 | B-1 | C-7 | E-3 |
| SC-47 | A-6 | B-2 | C-7 | E-3 |
| SC-48 | A-6 | B-3 | C-7 | E-3 |
| SC-49 | A-6 | B-4 | C-7 | E-3 |
| SC-50 | A-6 | B-7 | C-7 | E-3 |
| SC-51 | A-7 | B-1 | C-7 | E-3 |
| SC-52 | A-7 | B-2 | C-7 | E-3 |
| SC-53 | A-7 | B-3 | C-7 | E-3 |
| SC-54 | A-7 | B-4 | C-7 | E-3 |
| SC-55 | A-7 | B-7 | C-7 | E-3 |
| SC-56 | A-8 | B-1 | C-7 | E-3 |
| SC-57 | A-8 | B-2 | C-7 | E-3 |
| SC-58 | A-8 | B-3 | C-7 | E-3 |
| SC-59 | A-8 | B-4 | C-7 | E-3 |
| SC-60 | A-8 | B-7 | C-7 | E-3 |

A process for producing the composition according to the present invention, comprising the silver nanoplatelets, comprises the following steps:
(a) preparing a first solution comprising a silver precursor, at least one complexing agent, optionally a base, a compound of formula

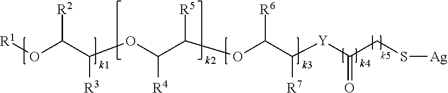

and water,
(b) preparing a reducing agent mixture comprising at least two reducing agents, optionally a base and water,
(c) combining the first solution with the reducing agent mixture so as to allow the silver precursor to react with the reducing agents, thereby synthesizing the composition, comprising the silver nanoplatelets.
R¹ is H, C₁-C₁₈alkyl, phenyl, C₁-C₈alkylphenyl, or CH₂COOH;
R², R³, R⁴, R⁵, R⁶ and R⁷ are independently of each other H, C₁-C₈alkyl, or phenyl;
Y is O, or NR⁸;
R⁸ is H, or C₁-C₈alkyl;
k1 is an integer in the range of from 1 to 500,
k2 and k3 are independently of each other 0, or integers in the range of from 1 to 250;
k4 is 0, or 1,
k5 is an integer in the range of from 1 to 5.

One compound, such as, for example, ammonia, an organoamine, methylglycine diacetic acid trisodium salt, or ethylenediaminetetraacetic acid tetrasodium salt, may simultaneously serve as complexing agent and base.

Preferably, the reaction of silver nanoplatelets formation is carried out at a total silver concentration of >1% w/w, especially >2% w/w, after combining the first solution with the reducing agent mixture solution.

Preferably, the reaction of silver nanoplatelets formation is carried out by gradually adding the silver precursor solution into reducing agent mixture solution, whereas the temperature of reducing agent mixture solution is in the range of 0-60° C. and the gradual addition is completed within 15 minutes to 10 h.

The silver precursor is preferably a silver(I) compound, selected from the group consisting of AgNO₃; AgClO₄; Ag₂SO₄; AgCl; AgF; AgOH; Ag₂O; AgBF₄; AgIO₃; AgPF₆; R²⁰⁰CO₂Ag, R²⁰⁰SO₃Ag, wherein R²⁰⁰ is unsubstituted or substituted C₁-C₁₈alkyl, unsubstituted or substituted C₅-C₈cycloalkyl, unsubstituted or substituted C₇-C₁₈aralkyl, unsubstituted or substituted C₆-C₁₈aryl or unsubstituted or substituted C₂-C₁₈heteroaryl; Ag salts of dicarboxylic, tricarboxylic, polycarboxylic acids, polysulfonic acids, P-containing acids and mixtures thereof.

AgNO₃, Ag₂O, AgClO₄, Ag₂SO₄, AgF, CH₃CO₂Ag, mono-, di- or trisilver citrate, CH₃SO₃Ag, CF₃SO₃Ag are more preferred, wherein AgNO₃ is most preferred.

Nonlimiting examples of complexing agents include ammonia, methylamine, dimethylamine, ethylamine, ethylenediamine, diethylenetriamine, ethylene-diamine-tetraacetic acid (EDTA); ethylenediamine N,N′-disuccinic acid (EDDS); methyl glycine diacetic acid (MGDA); diethylene triamine penta acetic acid (DTPA); propylene diamine tetracetic acid (PDT A); 2-hydroxypyridine-N-oxide (HPNO); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof, such as, for example, trisodium salt of methylglycinediacetic acid (Na₃MGDA) and tetrasodium salt of EDTA.

The reducing agent mixture comprises at least two reducing agents. One reducing agent is selected from the group consisting of alkali, or alkaline earth metal borohydrides, such as sodium borohydride, alkali, or alkaline earth metal acyloxyborohydrides, such as sodium triacetoxyborohydride, alkali, or alkaline earth metal alkoxy- or aryloxyborohydrides, such as sodium trimethoxyborohydride, aryloxyboranes, such as catecholborane, dialkylsulfide-borane complexes, such as dimethylsulfide borane, and amine-borane complexes, such as diethylaniline borane, tert-butylamine borane, morpholine borane, dimethylamine borane, triethylamine borane, pyridine borane, ammonia borane and mixtures thereof. The other reducing agent is selected from NH₂NH₂, mono- or dialkylhydrazines and mixtures thereof. In a particularly preferred embodiment the reducing agent mixture comprises morpholine borane complex and NH₂NH₂.

Preferably, the molar ratio of boron-containing reducing agent to hydrazine-type reducing agent is below 1 to 10, especially below 1 to 20.

Nonlimiting examples of base are alkali metal hydroxides, alkali earth metal hydroxides, alkali metal carboxylate salts, amines and combinations thereof. The most preferred base is NH₃.

Preferably, the process comprises the following steps.
(a) preparing a first solution comprising AgNO₃, diethylenetriamine and methylglycine diacetic acid trisodium salt, NH₃, a compound of formula

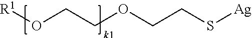

and water,
(b) preparing a reducing agent mixture comprising NH₃, hydrazine monohydrate and borane-morpholine complex,
(c) dosing the first solution into the reducing agent mixture to form the composition, comprising the silver nanoplatelets.

R¹ is H, or a C₁-C₈alkyl group and k1 is 22 to 450, especially 22 to 150.

The process is preferably carried out under inert atmosphere. Dosing the first solution into the reducing agent mixture solution within 15 minutes to 10 h.

The number mean diameter and the mean thickness silver nanoplatelets can be controlled by variation of temperature in the reactor with reducing agents solution during dosing of the precursor solution, hydrazine to borane ratio and dosing rate.

The silver nanoplatelets can be isolated by known methods such as decantation, filtration, centrifugation, reversible or irreversible agglomeration, phase transfer with organic solvent and combinations thereof. The silver nanoplatelets may be obtained after isolation as a wet paste or dispersion in water. The silver nanoplatelets content in the final preparation of said particles may be up to about 99% by weight, based on the total weight of the preparation, preferably between 5 to 99% by weight, more preferably 10-95% by weight.

A preferred aspect of the present invention relates to a method which comprises further a step d), wherein the dispersion of the silver nanoplatelets is concentrated and/or water is replaced at least partially with an organic solvent. Examples of suitable organic solvents are ethanol, 1-propanol, isopropanol, ethyl acetate, ethyl-3-ethoxypropionate and 1-methoxy-2-propanol, or mixtures thereof, optionally with water.

Optionally, further stabilizing agents may be added in step c) before water is removed.

In a further embodiment the present invention is directed to coatings, or printing inks, comprising the composition according to the present invention, comprising the silver nanoplatelets, which are described, for example, in WO2020/224982, WO2022/101207, WO2022/101224, WO2022/101225 and WO2022/167377A1.

The coating, or printing ink composition comprises
(i) the composition according to the present invention
(ii) a binder, and
(iii) optionally a solvent.

The silver nanoplatelets capped by a compound of formula (XX) are suited for use in security inks for producing security features for securing value documents, which exhibit a first color upon viewing in transmitted light and a second color different from the first color upon viewing in incident light, which are, for example, described in WO2022/101224 and WO2022/101225.

Part of WO2022/101224 is outlined below in excerpts.

WO2022/101224 describes UV-VIS radiation curable security inks, wherein said inks comprise:
a) from about 7.5 wt-% to about 20 wt-% of silver nanoplatelets capped by a compound of formula (XX);
b) a perfluoropolyether surfactant functionalized with at least a hydroxy group;
c) from about 3 wt-% to about 12 wt-% of a polyvinyl chloride copolymer containing at least 69 wt-% of vinyl chloride;
d)
   d1) from about 25 wt-% to about 55 wt-% of a cycloaliphatic epoxide, and from about 1 wt-% to about 10 wt-% of a cationic photoinitiator; or
   d2) from about 30 wt-% to about 65 wt-% of a mixture of a cycloaliphatic epoxide and a radically curable compound, from about 1 wt-% to about 6 wt-% of a cationic photoinitiator, and from about 1 wt-% to about 6 wt-% of a free radical photoinitiator; and optionally
e) a cationically curable compound selected from the group consisting of:
   e1) a vinyl ether having two vinyloxy residues in an amount lower than 50% of the weight percent (wt-%) of the cycloaliphatic epoxide of d);
   e2) a vinyl ether having one vinyloxy residue in an amount lower than about 5 wt-%;
   e3) an epoxide other than a cycloaliphatic epoxide in an amount lower than about 10 wt-%;
   e4) an oxetane having two oxetanyl residues in an amount lower than about 20 wt-%;
   e5) an oxetane having one oxetanyl residue in an amount lower than about 3.5 wt-%; and
   e6) a mixture of e1) and/or e2) and/or e3) and/or e4) and/or e5); the weight percents being based on the total weight of the UV-Vis radiation curable security ink; and
a process for producing a security feature for securing a value document, wherein said security feature exhibits a color upon viewing in transmitted light and a metallic color upon viewing in incident light, said process comprising the following steps:
A) printing, preferably by screen printing, rotogravure, or flexography, the UV-Vis radiation curable security ink on a transparent or partially transparent region of a substrate of a value document to provide an ink layer; and
B) UV-Vis curing the ink layer obtained at step A) to form the security feature.

The combination of the silver nanoplatelets capped by a compound of formula (XX) and the specific ink vehicle described in WO2022/101224 allows expedient migration of the silver nanoplatelets contained in an ink layer obtained by printing the security ink from the mass of the ink layer at the interface between the ink layer and air and at the interface between the ink layer and the substrate and alignment at said interfaces to form thin reflective layers, thereby producing independently of the thickness of the printed ink layer the metallic color in reflection and the color in transmission. The cationically curable binder or hybrid curable binder contained by the UV-Vis radiation curable security ink provides the dichroic security feature obtained from said ink with a high mechanical resistance. The UV-Vis radiation curable ink described therein has outstanding shelf stability.

A UV-Vis radiation cationically curable security ink may comprise:
a) from about 7.5 wt-% to about 20 wt-% of silver nanoplatelets capped by a compound of formula (XX);
b) a perfluoropolyether surfactant functionalized with at least a hydroxy group;
c) from about 3 wt-% to about 12 wt-% of a polyvinyl chloride copolymer containing at least 69 wt-% of vinyl chloride;
   d1) from about 25 wt-% to about 55 wt-% of a cycloaliphatic epoxide, and from about 1 wt-% to about 10 wt-% of a cationic photoinitiator; and optionally
e) a cationically curable compound selected from the group consisting of:
   e1) a vinyl ether having two vinyloxy residues in an amount lower than 50% of the weight percent (wt-%) of the cycloaliphatic epoxide of d);
   e2) a vinyl ether having one vinyloxy residue in an amount lower than about 5 wt-%, preferably lower than or equal to about 4.1 wt-%;
   e3) an epoxide other than a cycloaliphatic epoxide in an amount lower than about 10 wt-%;
   e4) an oxetane having two oxetanyl residues in an amount lower than about 20 wt-%;
   e5) an oxetane having one oxetanyl residue in an amount lower than about 3.5 wt-%, preferably lower than or equal to about 3.3 wt-%; and
   e6) a mixture of e1) and/or e2) and/or e3) and/or e4) and/or e5); the weight percents being based on the total weight of the UV-Vis radiation curable security ink.

A UV-Vis radiation hybrid curable security ink may comprise:
a) from about 7.5 wt-% to about 20 wt-% of silver nanoplatelets capped by a compound of formula (XX);
b) a perfluoropolyether surfactant functionalized with at least a hydroxy group;
c) from about 3 wt-% to about 12 wt-% of a polyvinyl chloride copolymer containing at least 69 wt-% of vinyl chloride;
   d2) from about 30 wt-% to about 65 wt-% of a mixture of a cycloaliphatic epoxide and a radically curable compound, from about 1 wt-% to about 6 wt-% of a cationic photoinitiator, and from about 1 wt-% to about 6 wt-% of a free radical photoinitiator; and optionally
e) a cationically curable compound selected from the group consisting of:
   e1) a vinyl ether having two vinyloxy residues in an amount lower than 50% of the weight percent (wt-%) of the cycloaliphatic epoxide of d);
   e2) a vinyl ether having one vinyloxy residue in an amount lower than about 5 wt-%, preferably lower than or equal to about 4.1 wt-%;
   e3) an epoxide other than a cycloaliphatic epoxide in an amount lower than about 10 wt-%;
   e4) an oxetane having two oxetanyl residues in an amount lower than about 20 wt-%;
   e5) an oxetane having one oxetanyl residue in an amount lower than about 3.5 wt-%, preferably lower than or equal to about 3.3 wt-%; and
   e6) a mixture of e1) and/or e2) and/or e3) and/or e4) and/or e5); the weight percents being based on the total weight of the UV-Vis radiation curable security ink.

Further details and preferences of the security inks are described in WO2022/101224 and WO2022/101225.

Radically curable compositions are, for example, described in WO2022/167377A1 and comprise
(A) silver nanoplatelets capped by a compound of formula (XX),
(B) one reactive diluent comprising 1 to 4 (meth)acrylate groups;
(C) one, or more urethane (meth)acrylates (C), which are obtainable by reaction of the following components:
(a) at least one isocyanate having two isocyanate groups,
(b) at least one polyalkylene oxide polyether having at least 2 hydroxyl groups,
(c) at least one hydroxy-functional (meth)acrylate having one hydroxyl group and one (meth)acrylate group,
(d) at least one compound having at least one isocyanate reactive group and at least one acid function,
(e) at least one basic compound which is present for neutralization or partial neutralization of the acid groups of component (d),
(f) optionally at least one monoalcohol having one hydroxy function;
(D) one, or more photoinitiators;
(E) optionally one, or more reactive diluents, which are different from component (B);
(F) optionally one, or more oligomers, which are different from component (C); (G) optionally one, or more surfactants;
(I) optionally one, or more polymeric binders; and
(H) optionally further additives.

The reactive diluent B) is preferably selected from dipropylene glycol diacrylate, tripropylene glycol diacrylate, dipropylene glycol dimethacrylate, tripropylene glycol dimethacrylate, diethylene glycol diacrylate, triethylene glycol diacrylate, diethylene glycol dimethacrylate, triethylene glycol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, cyclohexanediol diacrylate, cyclohexanediol dimethacrylate and cyclohexanedimethanol diacrylate. Dipropylene glycol diacrylate is most preferred.

The urethane (meth)acrylate (C) is preferably obtainable by reaction of the following components:
(a) at least one isocyanate having two isocyanate groups, which is selected from 4,4′-, 2,4′- and/or 2,2′-methylenedicyclohexyl diisocyanate (H12MDI), isophorone diisocyanates (IPDI), and tolylene 2,4- and/or 2,6-diisocyanate (TDI), and is especially TDI;
(b) at least one polyalkylene oxide polyether having at least 2 hydroxyl groups, which is selected from polyalkylene glycols of formula HO—[—Xᵢ—]ₙ₄—H, wherein Xᵢ for each i=1 to n4 independently of each other is selected from —CH₂—CH₂—O—, —CH₂—CH(CH₃)—O— and —CH(CH₃)—CH₂—O—, very especially —CH₂—CH₂—O— and n4 is an integer from 5 to 60 can, very especially 7 to 50;
(c) at least one hydroxy-functional (meth)acrylate having one hydroxyl group and one (meth)acrylate group, which is selected from 2-hydroxyethyl acrylate, 2-hydroxyethyl methacrylate, 2- or 3-hydroxypropyl acrylate, 2- or 3-hydroxypropyl methacrylate, 4-hydroxybutyl methacrylate and 4-hydroxybutyl acrylate, and is especially 2-hydroxyethyl acrylate;
(d) at least one compound having at least one isocyanate reactive group and at least one acid function, which is selected from dimethylolbutyric acid and dimethylolpropionic acid, and is especially dimethylolpropionic acid;
(e) if component (d) is present, at least one basic compound which is present for neutralization or partial neutralization of the acid groups of component (d), which is selected from sodium hydroxide, potassium hydroxide triethylamine, tri-n-butylamine, di-n-butylamine and ethyl diisopropylamine, and is especially di-n-butylamine;
(f) optionally at least one monoalcohol having one hydroxy function, which is selected from methanol, ethanol, n-propanol, isopropanol and n-butanol;
(g) optionally at least one compound having at least one primary and/or secondary amino group, which is selected from dimethylamine, diethylamine, diisopropylamine and di-n-butylamine, and is especially di-n-butylamine, wherein the preparation of the urethane (meth)acrylate (C) is done in the presence of a reactive diluent; which is selected from dipropylene glycol diacrylate, tripropylene glycol diacrylate, dipropylene glycol dimethacrylate, tripropylene glycol dimethacrylate, diethylene glycol diacrylate, triethylene glycol diacrylate, diethylene glycol dimethacrylate, triethylene glycol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, cyclohexanediol diacrylate, cyclohexanediol dimethacrylate and cyclohexanedimethanol diacrylate, and is especially dipropylene glycol diacrylate.

The photonitiator (D) is preferably a compound of the formula

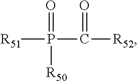

wherein
R₅₀ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂alkyl, C₁-C₁₂alkoxy, C₁-C₁₂alkylthio or by NR₅₃R₅₄;
or R₅₀ is unsubstituted C₁-C₂₀alkyl or is C₁-C₂₀alkyl which is substituted by one or more halogen, C₁-C₁₂alkoxy, C₁-C₁₂alkylthio, NR₅₃R₅₄ or by —(CO)—O—C₁-C₂₄alkyl;
R₅₁ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂alkyl, C₁-C₁₂alkoxy, C₁-C₁₂alkylthio or by NR₅₃R₅₄; or R₅₁ is —(CO)R′₅₂; or R₅₁ is C₁-C₁₂alkyl which is unsubstituted or substituted by one or more halogen, C₁-C₁₂alkoxy, C₁-C₁₂alkylthio, or by NR₅₃R₅₄;
R₅₂ and R′₅₂ independently of each other are unsubstituted cyclohexyl, cyclopentyl, phenyl, naphthyl or biphenylyl, or are cyclohexyl, cyclopentyl, phenyl, naphthyl or biphenylyl substituted by one or more halogen, C₁-C₄alkyl or C₁-C₄alkoxy; or R₅₂ is a 5- or 6-membered heterocyclic ring comprising an S atom or N atom;
R₅₃ and R₅₄ independently of one another are hydrogen, unsubstituted C₁-C₁₂alkyl or C₁-C₁₂alkyl substituted by one or more OH or SH wherein the alkyl chain optionally is interrupted by one to four oxygen atoms; or R₅₃ and R₅₄ independently of one another are C₂-C₁₂-alkenyl, cyclopentyl, cyclohexyl, benzyl or phenyl, or the photoinitiator (C) is a compound of the formula

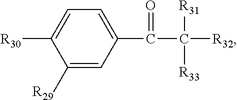

wherein
R₂₉ is hydrogen or C₁-C₁₈alkoxy;
R₃₀ is hydrogen, C₁-C₁₈alkyl, C₁-C₁₂hydroxyalkyl, C₁-C₁₈alkoxy, OCH₂CH₂—OR₃₄, morpholino, S—C₁-C₁₈alkyl, a group —HC═CH₂, —C(CH₃)═CH₂,

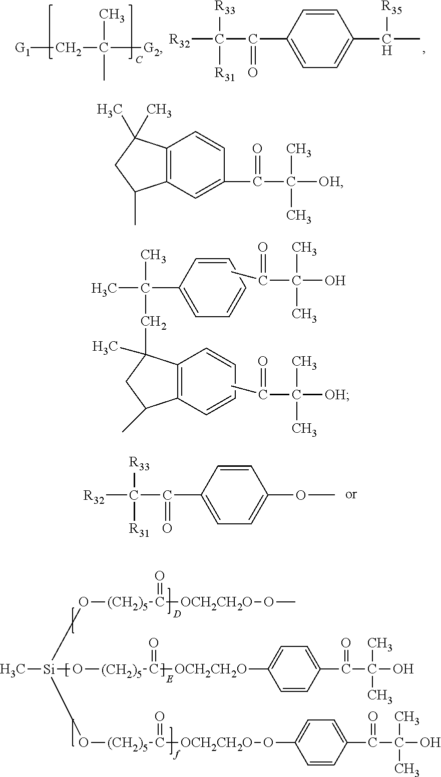

D, E and f are 1-3;
c is 2-10;
G₁ and G₂ independently of one another are end groups of the polymeric structure, preferably hydrogen or methyl;
R₃₄ is hydrogen,

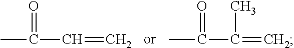

R₃₁ is hydroxy, C₁-C₁₆alkoxy, morpholino, dimethylamino or —O(CH₂CH₂O)_{g}—C₁-C₁₆alkyl;
g is 1-20;
R₃₂ and R₃₃ independently of one another are hydrogen, C₁-C₆alkyl, C₁-C₁₆alkoxy or —O(CH₂CH₂O)_{g}—C₁-C₁₆alkyl; or are unsubstituted phenyl or benzyl; or phenyl or benzyl substituted by C₁-C₁₂-alkyl; or R₃₂ and R₃₃ together with the carbon atom to which they are attached form a cyclohexyl ring;
R₃₅ is hydrogen, OR₃₆ or NR₃₇R₃₈;
R₃₆ is hydrogen, C₁-C₁₂alkyl which optionally is interrupted by one or more non-consecutive O-atoms and which uninterrupted or interrupted C₁-C₁₂alkyl optionally is substituted by one or more OH,
or R₃₆ is

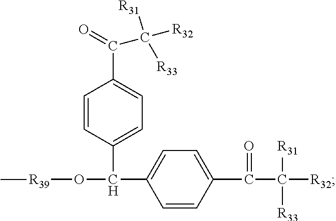

R₃₇ and R₃₈ independently of each other are hydrogen or C₁-C₁₂alkyl which is unsubstituted or is substituted by one or more OH;
R₃₉ is C₁-C₁₂alkylene which optionally is interrupted by one or more non-consecutive O, —(CO)—NH—C₁-C₁₂alkylene-NH—(CO)— or

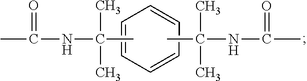

with the proviso that R₃₁, R₃₂ and R₃₃ not all together are C₁-C₁₆alkoxy or —O(CH₂CH₂O)_{g}—C₁-C₁₆alkyl, or the photoinitiator is a mixture of different compounds of the formula (XII), or the photoinitiator is a mixture of compounds of the formula (XII) and (XI).

Examples are mixtures of bis(2,6-dimethoxybenzoyl)-2,4,4-trimethylpentylphosphine oxide with 1-hydroxy-cyclohexyl-phenyl-ketone, of bis(2,4,6-trimethylbenzoyl)-phenylphosphine oxide with 2-hydroxy-2-methyl-1-phenyl-propan-1-one, of bis(2,4,6-trimethylbenzoyl)-phenylphosphine oxide with ethyl (2,4,6 trimethylbenzoyl phenyl) phosphinic acid ester, etc.

In another preferred embodiment the photoinitiator is a blend of an alpha-hydroxy ketone, alpha-alkoxyketone or alpha-aminoketone compound of the formula (XI) and a benzophenone compound of the formula (X); or a blend of an alpha-hydroxy ketone, alpha-alkoxyketone or alpha-aminoketone compound of the formula (XI), a benzophenone compound of the formula (X) and an acylphosphine oxide compound of the formula (XII).

Examples of suitable benzophenone compounds are compounds of the formula X:

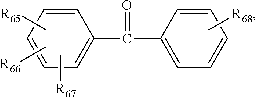

wherein
R₆₅, R₆₆ and R₆₇ independently of one another are hydrogen, C₁-C₄alkyl, C₁-C₄-halogenalkyl, C₁-C₄alkoxy, Cl or N(C₁-C₄alkyl)₂;
R₆₈ is hydrogen, C₁-C₄alkyl, C₁-C₄halogenalkyl, phenyl, N(C₁-C₄alkyl)₂, COOCH₃,

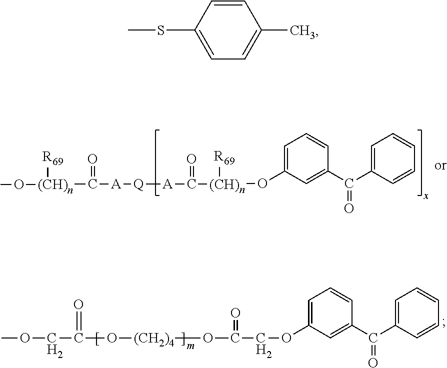

Q is a residue of a polyhydroxy compound having 2 to 6 hydroxy groups;
x is a number greater than 1 but no greater than the number of available hydroxyl groups in Q;
A is —[O(CH₂)_{b}CO]_{y}— or —[O(CH₂)_{b}CO]_{(y-1)}—[O(CHR₇₁CHR₇₀)ₐ]_{y}—;
R₆₉ is hydrogen, methyl or ethyl; and if n is greater than 1 the radicals R₆₉ may be the same as or different from each other;
a is a number from 1 to 2;
b is a number from 4 to 5;
y is a number from 1 to 10;
n2 is a number from 1 to 10; and
m is an integer 2-10.

Specific examples are benzophenone, a mixture of 2,4,6-trimethylbenzophenone and 4-methylbenzophenone, 4-phenylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 2,4,6-trimethylbenzophenone, 4-(4-methylthiophenyl)benzophenone, 3,3′-dimethyl-4-methoxybenzophenone, methyl-2-benzoylbenzoate, 4-(2-hydroxyethylthio)benzophenone, 4-(4-tolylthio)benzophenone, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl)benzophenone, 4-benzoyl-N,N-dimethyl-N-[2-(1-oxo-2-propenyl)oxy]ethylbenzenemethanaminium chloride; [4-(2-hydroxy-ethylsulfanyl)-phenyl]-(4-isopropylphenyl)-methanone; biphenyl-[4-(2-hydroxy-ethylsulfanyl)-phenyl]-methanone; biphenyl-4-yl-phenyl-methanone; biphenyl-4-yl-p-tolyl-methanone; biphenyl-4-yl-m-tolyl-methanone; [4-(2-hydroxy-ethylsulfanyl)-phenyl]-p-tolyl-methanone; [4-(2-hydroxy-ethylsulfanyl)-phenyl]-(4-isopropyl-phenyl)-methanone; [4-(2-hydroxy-ethylsulfanyl)-phenyl]-(4-methoxy-phenyl)-methanone; 1-(4-benzoyl-phenoxy)-propan-2-one; [4-(2-hydroxy-ethylsulfanyl)-phenyl]-(4-phenoxy-phenyl)-methanone; 3-(4-benzoyl-phenyl)-2-dimethylamino-2-methyl-1-phenyl-propan-1-one; (4-chloro-phenyl)-(4-octylsulfanyl-phenyl)-methanone; (4-chloro-phenyl)-(4-dodecylsulfanyl-phenyl)-methanone; (4-bromo-phenyl)-(4-octylsulfanyl-phenyl)-methanone; (4-dodecylsulfanyl-phenyl)-(4-methoxy-phenyl)-methanone; (4-benzoyl-phenoxy)-acetic acid methyl ester; biphenyl-[4-(2-hydroxy-ethylsulfanyl)-phenyl]-methanone; 1-[4-(4-benzoylphenylsulfanyl)phenyl]-2-methyl-2-(4-methylphenylsulfonyl)propan-1-one.

Examples of suitable alpha-hydroxy ketone, alpha-alkoxyketone or alpha-aminoketone compounds are of the formula (XI)

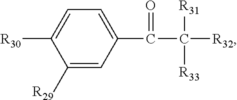

wherein
R₂₉ is hydrogen or C₁-C₁₈alkoxy;
R₃₀ is hydrogen, C₁-C₁₈alkyl, C₁-C₁₂hydroxyalkyl, C₁-C₁₈alkoxy, OCH₂CH₂—OR₃₄, morpholino, S—C₁-C₁₈alkyl, a group —HC═CH₂, —C(CH₃)═CH₂,

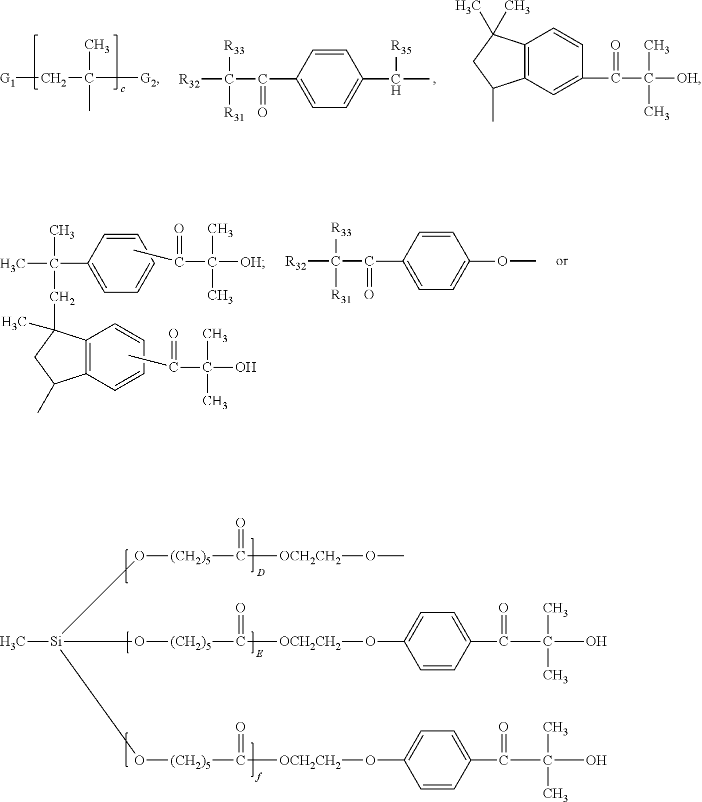

d, e and f are 1-3;
c is 2-10;
G₁ and G₂ independently of one another are end groups of the polymeric structure, preferably hydrogen or methyl;
R³⁴ is hydrogen,

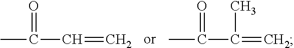

R₃₁ is hydroxy, C₁-C₁₆alkoxy, morpholino, dimethylamino or —O(CH₂CH₂O)_{g}—C₁-C₁₆alkyl;
g is 1-20;
R₃₂ and R₃₃ independently of one another are hydrogen, C₁-C₆alkyl, C₁-C₁₆alkoxy or —O(CH₂CH₂O)_{g}—C₁-C₁₆alkyl; or are unsubstituted phenyl or benzyl; or phenyl or benzyl substituted by C₁-C₁₂-alkyl; or R₃₂ and R₃₃ together with the carbon atom to which they are attached form a cyclohexyl ring;
R₃₅ is hydrogen, OR₃₆ or NR₃₇R₃₈;
R₃₆ is hydrogen, C₁-C₁₂alkyl which optionally is interrupted by one or more non-consecutive O-atoms and which uninterrupted or interrupted C₁-C₁₂alkyl optionally is substituted by one or more OH,
or R₃₆ is

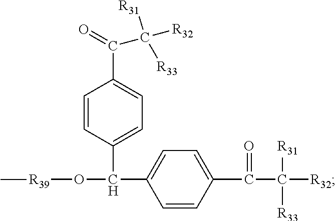

R₃₇ and R₃₈ independently of each other are hydrogen or C₁-C₁₂alkyl which is unsubstituted or is substituted by one or more OH;
R₃₉ is C₁-C₁₂alkylene which optionally is interrupted by one or more non-consecutive O, —(CO)—NH—C₁-C₁₂alkylene-NH—(CO)— or

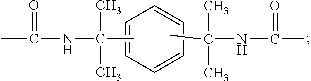

with the proviso that R₃₁, R₃₂ and R₃₃ not all together are C₁-C₁₆alkoxy or —O(CH₂CH₂O)_{g}—C₁-C₁₆alkyl.

Specific examples are 1-hydroxy-cyclohexyl-phenyl-ketone (optionally in admixture with benzophenone), 2-methyl-1[4-(methylthio)phenyl]-2-morpholinopropan-1-one, 2-benzyl-2-dimethylamino-1-(4-morpholinophenyl)-butan-1-one, 2-dimethylamino-2-(4-methyl-benzyl)-1-(4-morpholin-4-yl-phenyl)-butan-1-one, (3,4-dimethoxy-benzoyl)-1-benzyl-1-dimethylamino propane, 1-[4-(2-hydroxyethoxy)-phenyl]-2-hydroxy-2-methyl-1-propan-1-one, 2,2-dimethoxy-1,2-diphenylethan-1-one, 2-hydroxy-2-methyl-1-phenyl-propan-1-one, 2-hydroxy-1-{4-[4-(2-hydroxy-2-methyl-propionyl)-benzyl]-phenyl}-2-methyl-propan-1-one, 2-hydroxy-1-{4-[4-(2-hydroxy-2-methyl-propionyl)-phenoxy]-phenyl}-2-methyl-propan-1-one, 2-hydroxy-1-{1-[4-(2-hydroxy-2-methyl-propionyl)-phenyl]-1,3,3-trimethyl-indan-5-yl}-2-methyl-propan-1-one.

In certain cases it may be of advantage to use mixtures of two or more photoinitiators.

Further details and preferences of the radically curable compositions are described in WO2022/167377A1.

The UV-curable compositions according to the present invention may also comprise both, radically and cationically curable components and mixtures of radical and cationic photoinitiators.

The coating, or printing ink compositions of the present invention may be used for the production of decorative, or security elements.

Accordingly, the present application relates to security, or decorative elements, comprising a substrate, which may contain indicia or other visible features in or on its surface, and and on at least part of the said substrate surface, a coating, comprising the composition according to the present invention.

The coating, comprising the composition according to the present invention, shows a red, or magenta color in transmission and a greenish-metallic color in reflection.

Due to the simple buildup of the security element and the specific highest maximum absorption wavelength of the silver nanoplatelets a high protection against counterfeit is possible, making the element ideally suitable for banknotes, credit cards and the like.

As substrate the usual substrates can be used. The substrate may comprise paper, leather, fabric such as silk, cotton, tyvac, filmic material or metal, such as aluminium. The substrate may be in the form of one or more sheets or a web. The substrate may be mould made, woven, non-woven, cast, calendared, blown, extruded and/or biaxially extruded. The substrate may comprise paper, fabric, man made fibres and polymeric compounds. The substrate may comprise any one or more selected from the group comprising paper, papers made from wood pulp or cotton or synthetic wood free fibres and board. The paper/board may be coated, calendared or machine glazed; coated, uncoated, mould made with cotton or denim content, Tyvac, linen, cotton, silk, leather, polythyleneterephthalate, Propafilm® polypropylene, polyvinylchloride, rigid PVC, cellulose, tri-acetate, acetate polystyrene, polyethylene, nylon, acrylic and polyetherimide board. The polyethyleneterephthalate substrate may be Melinex type film (obtainable from DuPont Films Willimington Delaware, such as, for example, product ID Melinex HS-2), or oriented polypropylene.

The substrates being transparent films or non-transparent substrates like opaque plastic, paper including but not limited to banknote, voucher, passport, and any other security or fiduciary documents, self-adhesive stamp and excise seals, card, tobacco, pharmaceutical, computer software packaging and certificates of authentication, aluminium, and the like.

The substrates can be plain such as in metallic (e.g. Al foil) or plastic foils (e.g. PET foil), but paper is regarded also as a plain substrate in this sense.

Non-plain substrates or structured substrates comprise a structure, which was intentionally created, such as a hologram, or any other structure, created, for example, by embossing.

In a particularly preferred embodiment, the composition, comprising silver nanoplatelets with the highest wavelength absorption maximum being within the range of 450 to 550 nm, when measured in water dispersion, may be used in combination with compositions, comprising silver nanoplatelets with different highest wavelength absorption maximums to print dichromic, or trichromic patterns. Compositions, comprising silver nanoplatelets with different highest wavelength absorption maximum, i.e. having a highest wavelength absorption maximum being within the range of 580 to 1200 nm and showing a blue color in transmission and a gold color in reflection were described, for example, in WO11064162. In a particularly preferred embodiment a coating comprises areas with different silver nanoparticle compositions. The different areas may have a defined shape, such as, for example, a symbol, a stripe, a geometrical shape, a design, lettering, an alphanumeric character, the representation of an object or parts thereof.

The coating (or layer), comprising the composition according to the present invention, which shows a red, or magenta color in transmission and a greenish-metallic color in reflection, can be used as functional semitransparent and/or metallic layer in known decorative, or security elements, which are, for example, described in WO2011/064162, WO2014/041121, WO2014/187750, WO15120975A1, WO16091381A1, WO16173696, WO2017114590, WO2017092865, WO2017080641, WO2017028950, WO2017008897, WO2016173695 WO17054922A1 and WO17008905A3.

Accordingly, the present invention relates to
a security, or decorative element (the structure of which is described in more detail in WO2014/041121), comprising a) a substrate, b) a component with refractive index modulation, in particular a volume hologram, which is obtainable by exposing a recording material to actinic radiation and thereon c) a coating on at least a portion of the refractive index modulated layer, comprising the composition according to the present invention, which shows a red, or magenta color in transmission and a greenish-metallic color in reflection;
a security element (the structure of which is described in more detail in WO2014/187750), comprising
a) a substrate
b) a coating on at least a portion of the substrate comprising at least one liquid crystal compound, the coating being applied
on the reverse side of the substrate if the substrate is transparent or translucent or
on the surface side if the substrate is transparent, translucent, reflective or opaque and
c) a further coating on at least a portion of the coating containing the liquid crystal compound or direct on the substrate if the coating containing the liquid crystal compound is placed on the reverse side of the substrate,
the further coating comprising the composition according to the present invention, which shows a red, or magenta color in transmission and a greenish-metallic color in reflection;
a security element (the structure of which is described in more detail in WO16173696) for security papers, value documents, or the like, which consists of a multilayer structure capable of interference, wherein the multilayer structure capable of interference has a reflection layer, a dielectric layer, and a partially transparent layer, wherein the dielectric layer is arranged between the reflection layer and the partially transparent layer, wherein the reflection layer is formed by a colored layer, comprising the composition according to the present invention, which shows a red, or magenta color in transmission and a greenish-metallic color in reflection;
a security element (the structure of which is described in more detail in WO2017092865) for protecting documents of value, comprising a transparent carrier substrate, a layer containing a diffractive optical element (DOE) and a semi-transparent functional layer, comprising the composition according to the present invention, which shows a red, or magenta color in transmission and a greenish-metallic color in reflection;
a molded plastic film article (the structure of which is described in more detail in WO2017114590) for a blister, in particular a blister for tablets, comprising a transparent carrier substrate that includes a semi-transparent functional layer, comprising the composition according to the present invention, which shows a red, or magenta color in transmission and a greenish-metallic color in reflection;
a packaging (the structure of which is described in more detail in WO17054922A1) comprising a plastic film shaped part and a cover film, wherein said plastic film shaped part defines the front side of the packaging and the cover film defines the rear side of the packaging, and the cover film is based on a carrier substrate provided with a semi-transparent functional layer, comprising the composition according to the present invention, which shows a red, or magenta color in transmission and a greenish-metallic color in reflection;
a security, or decorative element, comprising a substrate, an UV lacquer layer on at least part of the substrate having on at least part of its surface a nano- or microstructure, such as, for example an OVD, and on at least part of the UV lacquer layer and/or on at least part of the nano- or microstructure layer, comprising the composition according to the present invention.

The method of producing the security element of the present invention comprises preferably the steps of
a) providing a substrate having a surface, which surface may contain indicia or other visible features, such as for example polyethylene terephthalate(PET) film, or a biaxially oriented polypropylene (BOPP) film;
b) applying on top of at least part of the said substrate surface a composition according to the present invention, comprising the silver nanoplatelets, and
c) optionally applying a protective layer on top of layer (b).

The application of layer c) is preferably done by gravure, flexographic, ink jet, offset, or screen printing process.

The protective layer (c) is applied on top of layer (b). The protective layer is preferably transparent or translucent. Examples for coatings are known to the skilled person. For example, water borne coatings, UV-cured coatings or laminated coatings may be used. UV-cured coatings are preferably derived from UV curable compositions which are preferably deposited by means of gravure, offset flexographic, ink jet, offset and screen printing process.

The UV curable composition comprises
(a) 1.0 to 20.0, especially 1.0 to 15.0, very especially 3.0 to 10.0% by weight of photoinitiator,
(b) 99.0 to 80.0, especially 99.0 to 85.0, very especially 97.0 to 90.0% by weight of a binder (unsaturated compound(s) including one or more olefinic double bonds),
wherein the amounts of components a) and b) adds up to 100%.

In a preferred embodiment the UV curable composition comprises (b1) an epoxy-acrylate (10 to 60%) and (b2) one or several (monofunctional and multifunctional) acrylates (20 to 90%) and (a) one, or several photoinitiators (1 to 15%). wherein the amounts of components a), b1) and b2) add up to 100%.

The epoxy-acrylate is selected from aromatic glycidyl ethers aliphatic glycidyl ethers. Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]). Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410-58-7]).

The one or several acrylates are preferably multifunctional monomers which are selected from trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, tripropylene glycol diacrylate (TPGDA), dipropylene glycol diacrylate (DPGDA), pentaerythritol diacrylate, pentaerythritol triacrylate, pentaerythritol tetraacrylate, dipentaerythritol diacrylate, dipentaerythritol triacry¬late, dipentaerythritol tetraacrylate, dipentaerythritol pentaacrylate, dipentaerythritol hexa¬acrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, triacrylate of singly to vigintuply alkoxylated, more preferably singly to vigintuply ethoxylated trimethylolpropane, singly to vigintuply propoxylated glycerol or singly to vigintuply ethoxylated and/or propoxylated pentaerythritol, such as, for example, ethoxylated trimethylol propane triacrylate (TMEOPTA) and or mixtures thereof.

In another preferred embodiment the UV curable composition comprises:

| | | |
|---|---|---|
| Bisphenol A epoxyacrylate with 25% TPGDA | 1-35% | by weight |
| Dipropylene glycol diacrylate (DPGDA) | 30-45% | by weight |
| Ethoxylated trimethylol propane triacrylate | 10-50% | by weight |
| (TMEOPTA) | | |
| Reactive tertiary amine | 1-15% | by weight |
| Photoinitiator: | 5-10% | by weight |

The amounts of the components—the of UV curable composition add up to 100% by weight.

In another preferred embodiment the UV curable composition comprises:

| | | |
|---|---|---|
| Tripropylene glycol diacrylate (TPGDA) | 1-25% | by weight |
| Dipropylene glycol diacrylate (DPGDA) | 30-45% | by weight |
| Ethoxylated trimethylol propane triacrylate | 10-50% | by weight |
| (TMEOPTA) | | |
| Reactive tertiary amine | 1-15% | by weight |
| Photoinitiator: | 5-9% | by weight |

The amounts of the components—the of UV curable composition add up to 100% by weight.

A photoinitiator is a molecule that creates reactive species (free radicals, cations or anions) when exposed to radiation (UV or visible wavelength range).

The photoinitiator is preferably a blend of an alpha-hydroxy ketone, alpha-alkoxyketone or alpha-aminoketone compound of the formula (XI) and a benzophenone compound of the formula (X); or a blend of an alpha-hydroxy ketone, alpha-alkoxyketone or alpha-aminoketone compound of the formula (XI), a benzophenone compound of the formula (X) and an acylphosphine oxide compound of the formula (XII).

The UV curable composition may comprise various additives. Examples thereof include thermal inhibitors, coinitiators and/or sensitizers, light stabilisers, optical brighteners, fillers and pigments, as well as white and coloured pigments, dyes, antistatics, wetting agents, flow auxiliaries, lubricants, waxes, anti-adhesive agents, dispersants, emulsifiers, anti-oxidants; fillers, e.g. talcum, gypsum, silicic acid, rutile, carbon black, zinc oxide, iron oxides; reaction accelerators, thickeners, matting agents, antifoams, leveling agents and other adjuvants customary, for example, in lacquer, ink and coating technology.

Examples of coinitiators/sensitisers are especially aromatic carbonyl compounds, for example benzophenone, thioxanthone, especially isopropyl thioxanthone, anthraquinone and 3-acylcoumarin derivatives, terphenyls, styryl ketones, and also 3-(aroylmethylene)-thiazolines, camphor quinone, and also eosine, rhodamine and erythrosine dyes. Amines, for example, can also be regarded as photosensitisers when the photoinitiator consists of a benzophenone or benzophenone derivative.

The security element of the invention can be affixed to a variety of objects through various attachment mechanisms, such as pressure sensitive adhesives or hot stamping processes, to provide for enhanced security measures such as anticounterfeiting. The security article can be utilized in the form of a label, a tag, a ribbon, a security thread, and the like, for application to a variety of objects such as security documents, monetary currency, credit cards, merchandise, etc.

Accordingly, the present invention is also directed to a product, comprising the security element according to the present invention, and to the use of the security element according to the present invention for the prevention of counterfeit or reproduction, on a document of value, right, identity, a security label or a branded good.

A method of detecting the authenticity of the security element according to the present invention may comprise the steps of:
a) measuring an absorbance, reflectance or transmittance spectrum of the security document in the VIS/NIR range of the electromagnetic spectrum; and
b) comparing the spectrum measured under a) and/or information derived therefrom with a corresponding spectrum and/or information of an authentic security element.

The composition of the present invention can used in methods for forming an optically variable image (an optically variable device), which are, for example, described in EP2886343A1, EP2886343A1, EP2886356B1, WO11064162, WO2013/186167 and WO14118567A1.

Accordingly, the present invention relates to
a method for forming an optically variable image (an optically variable device) on a substrate comprising the steps of: forming an optically variable image (OVI) on a discrete portion of the substrate; and depositing a coating, printing composition, comprising the composition according to the present invention on at least a portion of the OVI;
a method for forming a surface relief microstructure, especially an optically variable image (an optically variable device, OVD) on a substrate described in WO2013/186167 comprises the steps of:
A) applying a curable composition to at least a portion of the substrate wherein the curable composition comprises
a1) at least one ethylenically unsaturated resin, a monomer or a mixture thereof;
a2) at least one photoinitiator; and
a3) the composition according to the present invention;
B) contacting at least a portion of the curable composition with a surface relief microstructure, especially optically variable image forming means;
C) curing the composition by using at least one UV lamp.

The compositions, comprising silver nanoplatelets, which bear on their surface stabilizing agents and stabilizing agents may be used in the production of security elements, comprising prisms (US2014232100, WO18045429), lenses (US2014247499), and/or micromirrors (US2016170219).

The compositions, comprising silver nanoplatelets, which bear on their surface stabilizing agents and stabilizing agents may show surface enhanced Raman scattering (SERS).

Various aspects and features of the present invention will be further discussed in terms of the examples. The following examples are intended to illustrate various aspects and features of the present invention.

The following examples are intended to illustrate various aspects and features of the present invention.

### EXAMPLES

UV-Vis spectra of dispersions were recorded on Varian Cary 50 UV-Visible spectrophotometer at such concentration of dispersions as to achieve the optical density of 0.3 to 1.5 at 1 cm optical path.

The solids content of dispersions and solutions in water was determined using Mettler-Toledo HR-73 halogen moisture analyzer at 130° C.

TEM analysis was conducted on dispersions containing silver nanoplatelets in isopropanol using an EM 910 instrument from ZEISS, INST.109, in bright field mode at an e-beam acceleration voltage of 100 kV. At least 2 representative images with scale in different magnification (5.000×, 10.000× and 20.000×) were recorded in order to characterize the dominant particle morphology for each sample.

The “number mean diameter of the silver nanoplatelets” refers to the mean diameter determined by transmission electron microscopy (TEM) using Fiji image analysis software (or Image analysis software: ParticleSizer (Thorsten Wagner (2016) ij-particlesizer: ParticleSizer 1.0.9. Zenodo; 10.5281/zenodo.820296) and ImageJ version 1.53f51) based on the measurement of at least 300, especially at least 500 randomly selected silver nanoplatelets oriented parallel to the plane of a transmission electron microscopy image (TEM), wherein the diameter of a silver nanoplatelet is the maximum dimension of said silver nanoplatelet (maximal Feret diameter) oriented parallel to the plane of a transmission electron microscopy (TEM) image (recorded at magnification 20.000×).

The “number mean thickness of silver nanoplatelets” refers to the mean thickness determined by transmission electron microscopy (TEM) based on the measurement of at least 50, especially of at least 300 randomly selected silver nanoplatelets oriented perpendicular to the plane of the TEM image (recorded at magnification 25.000×), wherein the thickness of the silver nanoplatelet is the maximum thickness of said silver nanoplatelet. TEM analysis was conducted on dispersions containing silver nanoplatelets in isopropanol using an EM 910 instrument from ZEISS, INST.109, in bright field mode at an e-beam acceleration voltage of 100 kV.

In detail, a part of the dispersion is transferred to a smooth foil. After drying the sample is embedded in Araldit®, which is cross-linked below 60° C. Ultrathin cross-sections of the embedded sample are prepared perpendicular to the foil surface. The thickness of at least 300 randomly selected silver nanoplatelets may be determined from the cross-sectional TEM images (recorded at magnification 25.000×) by fitting ellipses to the cross-sectioned particles by the software (ParticleSizer). The minor axis (the shortest diameter) of the fitted ellipse is taken as particle thickness.

### Synthesis Example 1—Preparation of S-Vinylmercaptoethanol (VME) Ethoxylate

VME-ethoxylate is synthesized essentially according to Example 1h, described in EP3063188B1 with the reactant ratios described in Table 1.

| | | |
|---|---|---|
| S-vinylmercaptoethanol (VME) | 25 | g |
| Potassium methylate | 0.25 | g |
| Toluene | 75 | g |
| Ethylene oxide | 1160 | g |

The product had hydroxyl value of 25.5 mg KOH/g.

### Synthesis Example 2—Hydrolysis of VME-Ethoxylate

844 g of VME-ethoxylate are dissolved in 770 g of de-ionized water and the temperature is brought to 50° C. 26.85 g of silver nitrate are dissolved in 50.7 g water and the resulting solution is added to the solution of VME-ethoxylate in one portion. The mixture is stirred at 50° C. for 5 min, followed by addition of 37.5 g of methanesulfonic acid. The resulting mixture is stirred for 8 h at 50° C. and then pH was brought to ca. 5 by dropwise addition of 47.5 g of 50% w/w solution of NaOH in de-ionized water. The resulting solution, containing silver complex of O-(2-mercaptoethyl)-poly(ethylene glycol), is stored at room temperature and used for the synthesis of silver nanoplatelets without further purification.

### Example 1

### a) Synthesis of Silver Nanoplatelets

Preparation of Solution A: 925 g of the solution, obtained in Synthesis Example 2, are mixed with 250 g of de-ionized water. Separately, 720.5 g of silver nitrate are dissolved in 450 g of deionized water and both solutions are mixed at room temperature. 485.6 g of diethylenetriamine are added dropwise, while maintaining the temperature between 25 at 30° C. After the addition is complete, 211 g of 25% w/w ammonia solution in water and 114 g of methylglycine diacetic acid trisodium salt, 40% w/w solution in water, are added and the resulting solution is cooled to ca. +3° C.

Preparation of Solution B: 1170 g of de-ionized water are placed in a reactor and stirred at room temperature under vacuum (100 mbar) for 10 min. Vacuum is released with nitrogen gas, and the procedure is repeated another 2 times for removing the dissolved oxygen. Then 53 g of hydrazine monohydrate is added, followed by addition of 42.4 g of 25% w/w ammonia solution in water and the solution temperature is brought to 45° C. After that, 2 g of 1-octanol and 0.5 g of borane-morpholine complex are added and the mixture is stirred for 5 min at 45° C.

The whole amount of Solution A is dosed into Solution B with a constant rate over 75 min under the surface, while maintaining the temperature of Solution B at 45° C., resulting in a dispersion of silver nanoplatelets (total silver concentration 10.4% w/w).

### b) Isolation and Purification

The dispersion is cooled to 25° C., then 24 g of cpd. (B-3) are added to the dispersion and the stirring is continued for 1 h. The stirrer is stopped and the dispersion is allowed to sediment for 24 h at room temperature. Then 2300 g of supernatant are pumped out with a peristaltic pump, 2200 g of de-ionized water are added and the mixture is stirred for 1 h at room temperature. After that, 230 g of anhydrous sodium sulfate are added in portions with stirring. Stirring is continued for 20 min after addition of last portion of sodium sulfate, the stirrer is stopped and the dispersion is allowed to sediment for 24 h at room temperature. Then 2900 g of supernatant are pumped out with a peristaltic pump, 1000 g of de-ionized water are added and the mixture is stirred for 1 h at RT. The dispersion is subjected to ultrafiltration with an Al₂O₃ membrane (50 nm pore size) until dry content in supernatant after removal of nanoparticles by centrifugation at 13000 G for 3 h is reduced below 0.2% w/w.

Yield: 2360 g of silver nanoplatelets dispersion in water. Dry content of silver nanoplatelets in the resulting dispersion is 19.4% w/w, yield of silver nanoplatelets (based on total silver, introduced in reaction) is 90% as determined by TGA analysis (the residue at 600° C. is assumed to be pure silver without organic components).

Highest wavelength absorption maximum of the obtained silver nanoplatelets is located at 490 nm, when measured in water at ca. 5*10⁻⁵ M concentration of silver). FWHM of this maximum is 85 nm. Reference is made to FIG. 1, which shows the UV-Vis spectrum of composition, comprising silver nanoplatelets, obtained in Example 1b.

Mean diameter of the particles is 45±10 nm. Mean thickness of the particles is 18±2.4 nm (standard deviation is indicated after ±sign). Reference is made to FIG. 2, which is a TEM of the composition, comprising silver nanoplatelets, obtained in Example 1b.

### c) Surface Modification and Solvent Switch

199.2 g of dispersion of silver nanoplatelets, obtained in Step b) of Example 1 were placed in a round-bottom flask and concentrated in vacuo to ca. 40% solids content at 40° C. in the bath. 200 g of 1-propanol solution of 1.94 g of cpd. (C-9) are added. The mixture is concentrated on rotary evaporator to ca. 40% w/w of dry content, then 200 g of 1-propanol are added and the mixture is concentrated to 40% w/w of dry content measured at 130° C. Then 1.01 g (Dispersions D2, D3, D4) or 2.03 g (Dispersions D5, D6, D7) 2.03 g of octadecyl 3-mercaptopropionate are added and the mixture is stirred on a magnetic stirrer under inert atmosphere for 36 h at 50° C.

The resulting dispersion of surface-modified Ag nanoplatelets is used to prepare dispersions in different solvents or polymerizable monomers by distillation in vacuum after addition of the corresponding solvent or monomer (minimum pressure 10 mbar, bath temperature 40° C.). The solids content of dispersions is adjusted to 40% w/w, including Ag nanoplatelets, cpd. (B-3), cpd. (C-9) and cpd. of formula (Ia) and excluding the varying amount of octadecyl 3-mercaptopropionate (E-1) (hydrophobic modifier).

### Example 2

### a) Synthesis of Silver Nanoplatelets

Preparation of Solution A: 138.8 g of the solution, obtained in Synthesis Example 2, are mixed with a solution, comprising 110 g of de-ionized water and 108.1 g of silver nitrate (prepared separately) at room temperature. 72.9 g of diethylenetriamine are added dropwise, while maintaining the temperature between 25 at 30° C. After the addition is complete, 31.7 g of 25% w/w ammonia solution in water and 17.3 g of methylglycine diacetic acid trisodium salt, 40% w/w solution in water, are added and the resulting solution is cooled to 0° C.

Preparation of Solution B: 500 g of de-ionized water are placed in a reactor and stirred at room temperature under vacuum (100 mbar) for 10 min. Vacuum is released with nitrogen gas, and the procedure is repeated another 2 times for removing the dissolved oxygen. Then 31.8 g of hydrazine monohydrate (25% solution in water) is added, followed by addition of 6.45 g of 25% w/w ammonia solution in water and the solution temperature is brought to 35° C. After that, 1 g of 1-octanol and 5 mg of borane-morpholine complex (as a 1% solution in deionized water) are added and the mixture is stirred for 3 min at 35° C.

Then the whole amount of Solution A is dosed into Solution B under the surface via a dosing tube, cooled to 0° C., with a rate of 5 mL/min over the first 10 min of dosing, and 3 mL/min for the rest amount, while maintaining the temperature of Solution B at 35° C. A dispersion of silver nanoplatelets was obtained (total silver concentration 6.9% w/w).

### b) Isolation and Purification

The dispersion is cooled to 25° C., then 3.6 g of cpd. (B-3) (WO2020/083794 A1) are added to the dispersion and the stirring is continued for 1 h. The stirrer is stopped and the dispersion is allowed to sediment for 24 h at room temperature. Then 890 g of supernatant are pumped out with a peristaltic pump, 825 g of de-ionized water are added and the mixture is stirred for 1 h at room temperature. After that, 62 g of anhydrous sodium sulfate are added in portions with stirring. Stirring is continued for 20 min after addition of last portion of sodium sulfate, the stirrer is stopped and the dispersion is allowed to sediment for 24 h at room temperature. Then 920 g of supernatant are pumped out with a peristaltic pump, 825 g of de-ionized water are added and the mixture is stirred for 1 h at RT, followed by portion-wise addition of 60.5 g of anhydrous sodium sulfate. Stirring is continued for 20 min after addition of last portion of sodium sulfate, the stirrer is stopped and the dispersion is allowed to sediment for 24 h at room temperature. Then 885 g of supernatant are pumped out with a peristaltic pump, 800 g of de-ionized water are added and the mixture is stirred for 1 h at RT.

The resulting dispersion is subjected to ultrafiltration with an Al₂O₃ membrane (50 nm pore size) until dry content in supernatant after removal of nanoparticles by centrifugation at 13000 G for 3 h is reduced below 0.2% w/w.

Yield: 350 g of silver nanoplatelets dispersion in water. Dry content of silver nanoplatelets in the resulting dispersion is 18.4% w/w at 130° C., yield of silver nanoplatelets (based on total silver, introduced in reaction) is 87% as determined by TGA analysis (the residue at 600° C. is assumed to be pure silver without organic components).

Highest wavelength absorption maximum of the obtained silver nanoplatelets is located at 570 nm, when measured in water at ca. 5*10⁻⁵ M concentration of silver). FWHM value of this maximum is 120 nm.

### c) Surface Modification and Solvent Switch

210 g of dispersion of silver nanoplatelets in water, obtained in step b) were placed in a round-bottom flask and concentrated in vacuo to ca. 40% solids content at 40° C. in the bath. 200 g of 1-propanol solution and 1.94 g of cpd. C-9 are added. The mixture is concentrated on rotary evaporator to ca. 40% w/w of dry content, then 200 g of 1-propanol are added and the mixture is concentrated to 40% w/w of dry content measured at 130° C.

Then 1.02 g (Dispersion D9) or 1.22 g (Dispersion D10) of octadecyl 3-mercaptopropionate are added and the mixture is stirred on a magnetic stirrer under inert atmosphere for 36 h at 50° C.

The resulting dispersion of surface-modified Ag nanoplatelets are used to prepare dispersions in Dowanol™ PnP glycol ether and polymerizable monomers by distillation in vacuo (minimum pressure 10 mbar, bath temperature 40° C.). The solids content of dispersions is adjusted to 40% w/w, including Ag nanoplatelets, cpd. (B-3), cpd. (C-9) and cpd. of formula (Ia) and excluding the varying amount of octadecyl 3-mercaptopropionate (E-1) (hydrophobic modifier).

### Application Example 1

### A. Preparation of Comparative Security Inks (C1-C3) and Security Inks (E1-E12) According to the Present Invention

Ingredients provided in Tables 2a and 2b are independently mixed and dispersed at room temperature using a Dispermat CV-3 for 10 minutes at 2000 rpm so as to yield 50 g of the inks C1-C3 and E1-E12.

TABLE 1a
Ingredients of the ink vehicles

| | Commercial name | |
|---|---|---|
| Ingredient | (supplier) | Chemical composition (CAS number) |
| Polyvinylchloride | Vinnol ® H14/36 | 85.6 wt-% PVC + 14.4 wt-% PVAc (9003-22-9) |
| copolymer | (Wacker) | |
| Cycloaliphatic | Uvacure 1500 | 3,4-epoxycyclohexylmethyl 3,4-epoxycyclohexanecarboxylate (2386-87-0) |
| epoxide | (Allnex) | |
| Vinyl ether | CHDM-di (BASF) | 1,4-cyclohexanedimethanol divinyl ether (17351-75-6) |
| | DVE-3 (BASF) | triethylenegylcol divinylether (765-12-8) |
| Oxetane | Curalite ™ OX TMPO | 3-ethyl-3-(hydroxymethyl)oxetane (3047-32-3) |
| | (Perstorp) | |
| Acrylate oligomer | Ebecryl ® 2959 | 23 wt-% glycerol, propoxylated, esters with acrylic acid (52408-84-1) + 77 wt-% 4,4′- |
| | (Allnex) | Isopropylidene |
| | | diphenol, oligomeric reaction products with 1-chloro-2,3-epoxypropane, esters with acrylic |
| | | acid (55818-57-0) |
| Acrylate monomer | TMPTA (Allnex) | 2,2-bis(acryloyloxymethyl)butyl acrylate (15625-89-5) |
| Perfluoropolyether | Fluorolink ® E10H | Tetrafluoroethylene, oxidized, oligomers, reduced, methyl esters, reduced, reaction |
| reactive surfactant | (Solvay) | products with ethylene oxide (162492-15-1); Average molecular weight 1700 [g/mol] |
| Cationic | Speedcure 976 | 50 wt-% mixture of Sulfonium, diphenyl[4-(phenylthio)phenyl]-, (OC-6-11)- |
| photoinitiators | (Lambson) | hexafluoroantimonate(1-) (1:1) + Sulfonium, (thiodi-4,1-phenylene)bis[diphenyl-, (OC-6-11)- |
| | | hexafluoroantimonate(1-) (1:2) (71449-78-0 and 89452-37-9) in 50 wt-% propylene |
| | | carbonate (108-32-7) |
| | Omnicat 250 (BASF) | 75 wt-% Iodonium, (4-methylphenyl)[4-(2-methylpropyl)phenyl]-, hexafluorophosphate(1-) |
| | | (1:1) (344562-80-7) in 25 wt-% propylene carbonate (108-32-7) |
| Radical | Omnirad 2100 | 92.5% ethyl phenyl(2,4,6-trimethylbenzoyl)phosphinate (84434-11-7) + 7.5 wt-% phenyl |
| photoinitiator | (IGM Resins) | bis(2,4,6-trimethylbenzoyl)-phosphine oxide (448-61-3) |

TABLE 1b
Dispersions D1-D10

| | | Amount of | Cpd. of | Amount of cpd. | |
|---|---|---|---|---|---|
| Dispersion of Ag | Stabilizing | stabilizing | formula | of formula | Solvent/ |
| nanoplatelets | agent(s) | agent(s) [wt-%]^{a)} | (XX) | (XX) [wt-%]^{a)} | Monomer |
| Dispersion D1 | Cpd. C-9 | 5 | Cpd. E-1 | 0 | DVE-3 |
| Dispersion D2 | Cpd. C-9 | 5 | Cpd. E-1 | 2.625 | DVE-3 |
| Dispersion D3 | Cpd. C-9 | 5 | Cpd. E-1 | 2.625 | TMPO^{c)} |
| Dispersion D4 | Cpd. C-9 | 5 | Cpd. E-1 | 2.625 | ^{b)} |
| Dispersion D5 | Cpd. C-9 | 5 | Cpd. E-1 | 5.25 | DVE-3 |
| Dispersion D6 | Cpd. C-9 | 5 | Cpd. E-1 | 5.25 | HBVE^{d)} |
| Dispersion D7 | Cpd. C-9 | 5 | Cpd. E-1 | 5.25 | ^{b)} |
| Dispersion D8 | Cpd. C-9 | 5 | Cpd. E-1 | 0 | DVE-3 |
| Dispersion D9 | Cpd. C-9 | 5 | Cpd. E-1 | 2.625 | DVE-3 |
| Dispersion D10 | Cpd. C-9 | 5 | Cpd. E-1 | 3.15 | DVE-3 |

^{a)}based on solids content of dispersions, including cpd. (B-3) and cpd. of formula (Ia), obtained in Example 1, step b) (dispersions D1 to D7) and Example 2, step b) (dispersions D8 to D10)).
^{b)} Dowanol ™ PnP glycol ether.
^{c)}Curalite ™ OX TMPO.
^{d)}4-Hydroxybutylvinylether.

TABLE 2a
Composition of the UV-Vis cationically screen printing inks C1 and E1-E6

| | | Amount [wt-%] | | | | | | |
|---|---|---|---|---|---|---|---|---|
| Ingredient | Commercial name | C1 | E1 | E2 | E3 | E4 | E5 | E6 |
| Polyvinylchloride copolymer | Vinnol ® H14/36 | 7.4 | | | | | | |
| Cycloaliphatic epoxide | Uvacure ® 1500 | 33.6 | | | | | | |
| Vinyl ether | CHDME-di | 19.3 | | | | | | |
| | DVE-3 | 8.3 | | | | | | |
| Perfluoropolyether | Fluorolink ® E10H | 0.5 | | | | | | |
| surfactant | | | | | | | | |
| Cationic photoinitiator | Omnicat 250 | 5.9 | | | | | | |
| Dispersion Ag | Dispersion D1 | 25.0 | | | | | | |
| nanoplatelets | Dispersion D2 | | 25.0 | | 12.5 | | | |
| | Dispersion D3 | | | 25.0 | | | | |
| | Dispersion D4 | | | | 12.5 | | | |
| | Dispersion D5 | | | | | 25.0 | | 12.5 |
| | Dispersion D6 | | | | | | 25.0 | |
| | Dispersion D7 | | | | | | | 12.5 |

| Ag nanoplatelets (wt-%) | 10.0 | | | | | | |
|---|---|---|---|---|---|---|---|
| Amount of solvent (wt-%) | 1.5 | 1.5 | 1.5 | 9.0 | 1.5 | 1.5 | 9.0 |

TABLE 2b
Composition of the UV-Vis hybrid (cat/rad) curable screen printing inks C2, C3 and E7-E12

| | | Amount [wt-%] | | | | | | | |
|---|---|---|---|---|---|---|---|---|---|
| Ingredient | Commercial name | C2 | C3 | E7 | E8 | E9 | E10 | E11 | E12 |
| Polyvinylchloride copolymer | Vinnol ® H14/36 | 7.8 | | | | | | | |
| Cycloaliphatic epoxide | Uvacure ® 1500 | 22.2 | 33.0 | 27.2 | 27.2 | 22.2 | 36.9 | 22.2 | 36.9 |
| Vinyl ether | DVE-3 | 24.8 | 9.0 | 24.8 | 24.8 | 24.8 | 10.1 | 24.8 | 10.1 |
| Oxetane | Curalite ™ OX TMPO | 7.0 | | 2.0 | 2.0 | 7.0 | | 7.0 | |
| Perfluoropolyether | Fluorolink E10H | 1.0 | | | | | | | |
| surfactant | | | | | | | | | |
| Radical monomer | TMPA | 10.1 | | | | | | | |
| Radical oligomer | Ebecryl ® 2959 | 5.1 | | | | | | | |
| Cationic photoinitiator | Speedcure 976 | 5.9 | | | | | | | |
| Radical photoinitiator | Omnirad 2100 | 3.1 | | | | | | | |
| Dispersion Ag | Dispersion D1 | 13.0 | | | | | | | |
| nanoplatelets | Dispersion D2 | | | 13.0 | | | | | |
| | Dispersion D3 | | | | 13.0 | | | | |
| | Dispersion D8 | | 25.0 | | | | | | |
| | Dispersion D9 | | | | | 13.0 | 20.0 | | |
| | Dispersion D10 | | | | | | | 13.0 | 20.0 |

| | | | | | | | | |
|---|---|---|---|---|---|---|---|---|
| Ag nanoplatelets (wt-%) | 5.2 | 10.0 | 5.2 | 5.2 | 5.2 | 8.0 | 5.2 | 8.0 |
| Amount of solvent (wt-%) | 3.0 | 3.0 | 3.0 | 3.0 | 3.0 | 3.0 | 3.0 | 3.0 |

### B. Preparation of Security Features

The UV-Vis radiation curable screen printing hybrid security inks C1-C3 and E1-E12 described at item A are independently applied on pieces of transparent polymer substrate (PET Hostaphan® RN, thickness 50 μm, supplied by Putz GmbH+Co. Folien KG) using a 160 thread/cm screen (405 mesh). The printed pattern has a size of 5 cm×5 cm. 10 seconds after the printing step, the pieces of printed substrate are independently cured at room temperature by exposing them two times at a speed of 100 m/min to UV-Vis light under a dryer from IST Metz GmbH (two lamps: iron-doped mercury lamp 200 W/cm²+mercury lamp 200 W/cm²), to generate security features.

### C. Results (Optical Properties) of Security Features

The optical properties of each security features obtained at item B are independently assessed in reflection and visually using the tests described below. The results are summarized in Tables 3a and 3b.

Reflection measurements are performed using a goniometer (Goniospektrometer Codec WI-10 5&5 by Phyma GmbH Austria). The L*a*b* values of the printed security features are determined at 0° to the normal with an illumination angle of 22.5° on the side of the transparent polymer substrate that is printed. The C* values (chroma, corresponding to a measure of the color intensity or color saturation) are calculated from a* and b* values according to the CIELAB (1976) color space, wherein:

$${C}^{*} = \sqrt{{( {a}^{*} )}^{2} + {( {b}^{*} )}^{2}}$$

The C* values (reflection 22.5/0°) are displayed in Tables 3a and 3b below.

A visual assessment is carried out observing each security feature with the naked eye in reflection with a diffuse source (such as the light coming through a window without direct sun, the observer facing the wall opposite to the window). The following colors have been observed:
Dark brown to brown colors with matte appearance and no metallic effect;
Gold color or green color with glossy appearance and metallic effect. The metallic effect appears for a chroma value C* in reflection 22.5/0° higher than about 20.

A visual assessment is also carried out observing each security feature with the naked eye in transmission. The following colors have been observed:
Dull blue/dull magenta: the blue or magenta coloration is weak (but visible);
Blue/magenta: the blue/magenta coloration is intense.

TABLE 3a
Color properties of security features obtained from UV-Vis
cationically curable screen printing inks C1 and E1-E6

| | C1 | E1 | E2 | E3 | E4 | E5 | E6 |
|---|---|---|---|---|---|---|---|
| C* (reflection | 15.9 | 31.2 | 32.4 | 27.8 | 29.9 | 27.4 | 28.8 |
| 22.5/0°) | | | | | | | |
| Color (reflection) | Brown | Green | Green | Green | Green | Green | Green |
| Color (transmission) | Dull | Magenta | Magenta | Magenta | Magenta | Magenta | Magenta |
| | magenta | | | | | | |

As shown in Table 3a, the security features obtained from the UV-Vis cationically curable screen printing ink C1 (no hydrophobic treatment) yield a security feature exhibiting a brown, non-metallic appearance in reflection and a dull magenta color in transmission. Conversely, the security features obtained from the UV-Vis cationically curable screen printing inks E1-E6 according to the invention exhibit green color in reflection with a metallic appearance and magenta color in transmission.

TABLE 3b
Color properties of security features obtained from UV-Vis hybrid
(cat/rad) curable screen printing inks C2-C3 and E7-E12

| | C2 | C3 | E7 | E8 | E9 | E10 | E11 | E12 |
|---|---|---|---|---|---|---|---|---|
| C* (reflection | 19.5 | 6.5 | 25.7 | 24.3 | 32.8 | 40.0 | 26.0 | 21.3 |
| 22.5/0°) | | | | | | | | |
| Color (reflection) | Brown | Brown | Green | Green | Gold | Gold | Gold | Gold |
| Color (transmission) | ¹⁾ | Dull | ²⁾ | ²⁾ | Blue | Blue | Blue | Blue |
| | | blue | | | | | | |

¹⁾ Dull magenta;
²⁾ Magenta.

As shown in Table 3b, the security features obtained from the UV-Vis hybrid (cat/rad) curable screen printing inks C2 and C3 (no hydrophobic treatment) yield security features exhibiting a brown, non-metallic appearance in reflection and a dull blue or dull magenta color in transmission. Conversely, the security features obtained from the UV-Vis cationically curable screen printing inks E7-E12 according to the invention exhibit gold or green color in reflection with a metallic appearance and blue or magenta color in transmission.

1.-15. (canceled)

16. A composition, comprising silver nanoplatelets, wherein the silver nanoplatelets are capped by a compound of formula R 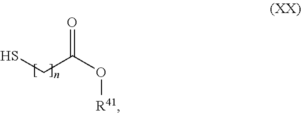
wherein
R⁴¹ is a C₄-C₂₅alkyl group, which may be interrupted by one, or more oxygen atoms and/or C═C double bonds; and
n is a number 1 to 10.

17. The composition according to claim 16, wherein the compound of formula (XX) is selected from HS(CH₂)₂C(C═O)O(CH₂)₁₇CH₃ (E-1), HS(CH₂)₂C(C═O)O(CH₂)₁₆CH₃ (E-2), HS(CH₂)₂C(C═O)O(CH₂)₁₅CH₃ (E-3), HS(CH₂)₂C(C═O)O(CH₂)₁₄CH₃ (E-4), HS(CH₂)₂C(C═O)O(CH₂)₁₃CH₃ (E-5), HS(CH₂)₂C(C═O)O(CH₂)₁₂CH₃ (E-6), HS(CH₂)₂C(C═O)O(CH₂)₁₁CH₃ (E-7), HS(CH₂)₂C(C═O)O(CH₂)₁₀CH₃ (E-8), HSCH₂C(C═O)O(CH₂)₁₇CH₃ (E-9), HSCH₂C(C═O)O(CH₂)₁₆CH₃ (E-10), HSCH₂C(C═O)O(CH₂)₁₅CH₃ (E-11), HSCH₂C(C═O)O(CH₂)₁₄CH₃ (E-12), HSCH₂C(C═O)O(CH₂)₁₃CH₃ (E-13), HSCH₂C(C═O)O(CH₂)₁₂CH₃ (E-14), HSCH₂C(C═O)O(CH₂)₁₁CH₃ (E-15), HSCH₂C(C═O)O(CH₂)₁₀CH₃ (E-16), HS(CH₂)₃C(C═O)O(CH₂)₁₇CH₃ (E-17), HS(CH₂)₃C(C═O)O(CH₂)₁₆CH₃ (E-18), HS(CH₂)₃C(C═O)O(CH₂)₁₅CH₃ (E-19), HS(CH₂)₃C(C═O)O(CH₂)₁₄CH₃ (E-20), HS(CH₂)₃C(C═O)O(CH₂)₁₃CH₃ (E-21), HS(CH₂)₃C(C═O)O(CH₂)₁₂CH₃ (E-22), HS(CH₂)₃C(C═O)O(CH₂)₁₁CH₃ (E-23), HS(CH₂)₃C(C═O)O(CH₂)₁₀CH₃ (E-24), and mixtures thereof.

18. The composition according to claim 16, comprising silver nanoplatelets, wherein the mean diameter of the silver nanoplatelets, present in the composition, is in the range of 30 to 60 nm with standard deviation being less than 50%, and the mean thickness of the silver nanoplatelets, present in the composition, is in the range of 5 to 30 nm with standard deviation being less than 50%, wherein the mean aspect ratio of the silver nanoplatelets is higher than 1.5.

19. The composition according to claim 16, comprising silver nanoplatelets, wherein the mean diameter of the silver nanoplatelets, present in the composition, is in the range of 50 to 100 nm with standard deviation being less than 50%, and the mean thickness of the silver nanoplatelets, present in the composition, is in the range of 8 to 25 nm with standard deviation being less than 50%, wherein the mean aspect ratio of the silver nanoplatelets is higher than 1.7.

20. The composition according to claim 16, comprising silver nanoplatelets, wherein the mean diameter of the silver nanoplatelets, present in the composition, is in the range of 15 to 35 nm with standard deviation being less than 50%, and the mean thickness of the silver nanoplatelets, present in the composition, is in the range of 5 to 20 nm with standard deviation being less than 50%, wherein the mean aspect ratio of the silver nanoplatelets is higher than 1.5.

21. The composition according to claim 16, wherein the silver nanoplatelets bear a surface stabilizing agent of formula 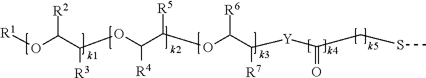
on their surface, wherein
R¹ is H, C₁-C₁₈alkyl, phenyl, C₁-C₈alkylphenyl, or CH₂COOH;
R², R³, R⁴, R⁵, R⁶ and R⁷ are independently of each other H, C₁-C₈alkyl, or phenyl;
Y is O, or NR⁸;
R⁸ is H, or C₁-C₈alkyl;
k1 is an integer in the range of from 1 to 500,
k2 and k3 are independently of each other 0, or integers in the range of from 1 to 250;
k4 is 0, or 1, and
k5 is an integer in the range of from 1 to 5.

22. The composition according to claim 21, wherein the surface stabilizing agent is of formula 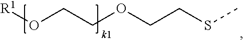
wherein
R¹ is H, or a C₁-C₈alkyl group, and
k1 is 22 to 450.

23. The composition according to claim 16, which comprises one, or more stabilizing agents selected from the group consisting of compounds of formula 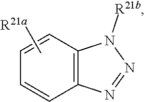
wherein
R^{21a} is a hydrogen atom, a halogen atom, a C₁-C₈alkoxy group, or a C₁-C₈alkyl group,
R^{21b} is a hydrogen atom, or a group of formula —CHR²⁴—N(R²²)(R²³),
R²² and R²³ are independently of each other a C₁-C₈alkyl, a hydroxyC₁-C₈alkyl group, or a group of formula —[(CH₂CH₂)—O]ₙ₁—CH₂CH₂—OH, wherein n1 is 1 to 5, and
R²⁴ is H or C₁-C₈alkyl.

24. The composition according to claim 16, which comprises one, or more stabilizing agents selected from the group consisting of compounds of formula 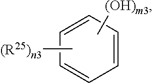
wherein
R²⁵ can be the same, or different in each occurrence and is a hydrogen atom, a halogen atom, a C₁-C₁₈alkyl group, a C₁-C₁₈alkoxy group, or a group —C(═O)—R²⁶,
R²⁶ is a hydrogen atom, a hydroxy group, a C1-C₁₈alkyl group, unsubstituted or substituted aminogroup, unsubstituted or substituted phenyl group, or a C1-C₁₈alkoxy group, and
n3 is a number of 1 to 4,
m3 is a number of 2 to 4, and
the sum of m3 and n3 is 6.

25. A coating, or printing ink composition, comprising the composition according to claim 16.

26. A security, or decorative element, comprising a substrate, which may contain indicia or other visible features in or on its surface, and on at least part of the said substrate surface, a coating obtainable from the composition according to claim 16.

27. The security, or decorative element according to claim 26, wherein the security element comprises a substrate, a coating on at least a portion of the substrate comprising at least one liquid crystal compound, the coating being applied on the reverse side of the substrate if the substrate is transparent or translucent or on the surface side if the substrate is transparent, translucent, reflective or opaque and a further coating on at least a portion of the coating containing the liquid crystal compound or direct on the substrate if the coating containing the liquid crystal compound is placed on the reverse side of the substrate, the further coating is obtained from the composition; or
the security element consists of a mutlilayer structure capable of interference, wherein the multilayer structure capable of interference has a reflection layer, a dielectric layer, and a partially transparent layer, wherein the dielectric layer is arranged between the reflection layer and the partially transparent layer, wherein the reflection layer is formed by a colored layer obtained from the composition; or
the security element comprises a transparent carrier substrate, a layer containing a diffractive optical element (DOE) and a semi-transparent functional layer obtained from the composition; or
the security, or decorative element is a blister for tablets, comprising a transparent carrier substrate that includes a semi-transparent functional layer obtained from the composition; or
the security, or decorative element is a packaging comprising a plastic film shaped part and a cover film, wherein said plastic film shaped part defines the front side of the packaging and the cover film defines the rear side of the packaging, and the cover film is based on a carrier substrate provided with a semi-transparent functional layer obtained from the composition; or
a security, or decorative element, comprising a substrate, a component with refractive index modulation, in particular a volume hologram, which is obtainable by exposing a recording material to actinic radiation and thereon a coating on at least a portion of the refractive index modulated layer obtained from the composition; or
a security, or decorative element, comprising a substrate, an UV lacquer layer on at least part of the substrate having on at least part of its surface a nano- or microstructure, and on at least part of the UV lacquer layer and/or on at least part of the nano- or microstructure layer a coating obtained from the composition.

28. A product, comprising the security or decorative element according to claim 26.

29. Use of the security or decorative element according to claim 25 for the prevention of counterfeit or reproduction, on a document of value, right, identity, a security label or a branded good.

30. A process for producing the composition according to claim 16, comprising the silver nanoplatelets, the process comprising:
(a) preparing a first solution comprising a silver precursor, at least one complexing agent, optionally a base, a compound of formula 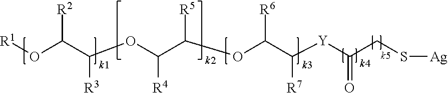
and water,
(b) preparing a reducing agent mixture comprising at least two reducing agents, optionally a base and water,
(c) combining the first solution with the reducing agent mixture so as to allow the silver precursor to react with the reducing agents, thereby synthesizing the composition, comprising the silver nanoplatelets, wherein
R¹ is H, C1-C₁₈alkyl, phenyl, C₁-C₈alkylphenyl, or CH₂COOH;
R², R³, R⁴, R⁵, R⁶ and R⁷ are independently of each other H, C₁-C₈alkyl, or phenyl;
Y is O, or NR⁸;
R⁸ is H, or C₁-C₈alkyl;
k1 is an integer in the range of from 1 to 500,
k2 and k3 are independently of each other 0, or integers in the range of from 1 to 250;
k4 is 0, or 1, and
k5 is an integer in the range of from 1 to 5;
(d) optionally concentration of the dispersion of the silver nanoplatelets and/or replacement of water at least partially with an organic solvent, such as, for example, ethanol, isopropanol, ethyl acetate, ethyl-3-ethoxypropionate and 1-methoxy-2-propanol, or mixtures thereof, optionally with water;
(e) adding a compound of formula 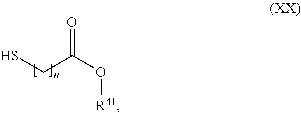
wherein
R⁴¹ is a C₄-C₂₅alkyl group, which may be interrupted by one, or more oxygen atoms, and
n is a number 1 to 10 after completion of step d); and
(f) optionally adding further stabilizing agents in step c) before water is removed; or after completion of step d).
